(19) United States
(12) Patent Application Publication
(10) Pub. No.: US 2008/0053379 A1
(43) Pub. Date: Mar. 6, 2008

(54) Animal cleaner apparatus

(76) Inventor: Eli Markewitz, Brooklyn, NY (US)

Correspondence Address: BERNARD MALINA, ESQ.;MALINA & ASSOCIATES, P.C., Suite 501, 60 East 42nd Street, New York, NY, 10165, US

(21) Appl. No.: 11/498,575

(22) Filed: Aug. 3, 2006

(51) Int. Cl. A01K 13/00

(52) U.S. Cl. 119/600

(57) ABSTRACT

A cleaner apparatus includes provisions for feeding, cleaning, grooming, attracting animals, controlling animals, treating, conditioning claws, provision of adjustable maze structures, atmospheric conditioning, removing loose hair, removing dander, dirt and application of various treatments.

This application claims priority from U.S. Provisional Patent Application Ser. No. 60/648,818, filed on Feb. 1, 2005 and application Ser. No. 11/344,435 filed Jan. 31, 2006.

### FIELD OF THE INVENTION

The present invention relates generally to the field of animal care and more particularly, to an animal care apparatus.

### BACKGROUND OF THE INVENTION

The field of animal care equipment includes a wide range of devices. However, despite the developments of the prior art, there remains a need for an effective animal cleaner apparatus.

It is an object of the invention to provide an effective animal cleaner apparatus which provides a single apparatus for care, feeding and cleaning of animals.

Other objects of the invention will be made clear hereinafter.

### OBJECTS AND SUMMARY OF THE INVENTION

The animal cleaner apparatus includes provisions for: feeding, cleaning, grooming, attracting animals, controlling animals, treating, conditioning claws, provision of an adjustable maze structures, atmospheric conditioning, removing loose hair, removing dander and dirt, application of various treatments, provision of litterbox capability and additional features as described below.

The invention includes a plurality of modules which provide the various functions. The modules are mounted on a plurality of tracks which are mounted in one or more enclosures. The enclosures may be connected to form a range of configurations.

### BRIEF DESCRIPTION OF THE DRAWINGS

Other important objects and advantages of the invention will be apparent from the following detailed description of the invention taken in connection with the accompanying drawings in which:

The various features of the invention are shown in the following drawings:

FIG. 1 is an overall perspective view of an animal cleaner apparatus showing an enclosure with sliding panels;

FIG. 2 is a schematic view of an enclosure in which the light goes on when an animal enters;

FIG. 3 is a perspective view of an adjustable molded rubber unit including a plurality of bristles;

FIG. 4 is a plan view of a non-tearable fabric sheet;

FIG. 5 is a perspective view of a frame;

FIG. 6 is an exploded view of the front portion of an enclosure showing the frame;

FIG. 7 is a perspective view of a frame with stretchable electrostatic shades;

FIG. 8 is a perspective view of a frame with motorized curtains;

FIG. 9 is a schematic view of a hanging electric flea zapper;

FIG. 10 is a schematic view of a carpet with a wax layer;

FIG. 11 is a schematic view of a hair singe device;

FIG. 12 is a perspective view of a nail groomer device;

FIG. 13 is a schematic view of a nail filer;

FIG. 14 is a schematic view of a lint remover brush;

FIG. 15 is a schematic view of an animal tail brush;

FIG. 16 is a schematic view of a feeder/noise/light unit;

FIG. 17 is a schematic view of an animal speaker/microphone/transmitter unit;

FIG. 18 is a schematic view of a transmitter for a radio controlled harness;

FIG. 19 is a schematic view of an electrode collar;

FIG. 20 is a schematic view of an electrode suit for an animal;

FIG. 21 is a schematic view of an anti-bacterial sticky carpet;

FIG. 22 is a schematic view of an enclosure showing tracks, a maze and various connecting chambers;

FIG. 23 is an enlarged fragmentary view of a portion of the adjustable maze;

FIG. 24 is a schematic view of an adjustable maze with fabric walls;

FIG. 25 is a schematic view of a mist sprayer unit;

FIG. 26 is a schematic view of a vacuum cleaner unit;

FIG. 27 is a schematic view of a movable food tray;

FIG. 28 is a schematic view of a feeder/refrigeration spray unit;

FIG. 29 is a schematic view of a static electricity generator/animal feeder unit;

FIG. 30 is a schematic view of a stack tray feeder;

FIG. 31 is a schematic view of a hooded feeder;

FIG. 32 is a schematic view of a body shield sprayer feeder;

FIG. 33 is a schematic view of a mist sprayer unit;

FIG. 34 is a schematic view of an alternative mist sprayer unit;

FIG. 35 is a schematic view of a feeder with top loading duct supply;

FIG. 36 is a schematic view of a litter box maze;

FIG. 37 is a schematic view of a wee-wee pad with a screened litter box;

FIG. 38 is a schematic view of a food chute;

FIG. 39 is a schematic view of a litter box with a bottom door;

FIG. 40 is a schematic view of a litter tray with a waster duct;

FIG. 41 is a schematic view of a control unit;

FIG. 42 is a schematic view of a fabric/magnet/stretchable curtain switch;

FIG. 43 is a schematic view of a charcoal odor absorber;

FIG. 44 is a schematic view of an enhanced vacuum cleaner;

FIG. 45 is a schematic view of a room environment protector;

FIG. 46 is a schematic view of a steamer;

FIG. 47 is a schematic view of a vacuum cleaner with sensors;

FIG. 48 is a schematic view of a vacuum blower ionizer;

FIG. 49 is a schematic view of a wireless control unit;

FIG. 50 is a schematic view of an air refrigerator-blower;

FIG. 51 is a schematic view of an enclosure with spray unit;

FIG. 52 is a schematic view of a ventilator;

FIG. 53 is a perspective view of a weight tank for an enclosure;

FIG. 54 is a perspective view of a flexible entry duct;

FIG. 55 is a perspective view of a platform bladder;

FIG. 56 is a schematic view of a feeder/sprayer;

FIG. 57 is a schematic view of an enclosure showing a plurality of chambers;

FIG. 58 is a schematic view of an enhanced vacuum cleaner system;

FIG. 59 is a schematic view of a tray with dual roll paper pad;

FIG. 60 is a schematic view of a dual sensor hair erector and a dispensing system;

FIG. 61 is a schematic view of a tray with elastic apertures;

FIG. 62 is a schematic view of an adjustable nozzle;

FIG. 63 is a schematic view of a barrier with an adjustable opening;

FIG. 64 is a schematic view of a dual sensor unit;

FIG. 65 is a schematic view of a tray with stones to treat nails;

FIG. 66 is a schematic view of a dish with dry ice compartment;

FIG. 67 is a schematic view of a hand-held brush with vacuum, blower, UV light, ionizer and flea zapper;

FIG. 68 is a schematic view of a door opening with a treatment unit;

FIG. 69 is a schematic view of a carpet with a wax layer;

FIG. 70 is a schematic view of a door space saver;

FIG. 71 is a schematic view of a collar with multiple electric pins;

FIG. 72 is a schematic view of a vaporizer unit with a broad dispersion baffle;

FIG. 73 is a schematic view of a vaporizer unit;

FIG. 74 is a schematic view of a combination cleaner and collar;

FIG. 75 is cancelled;

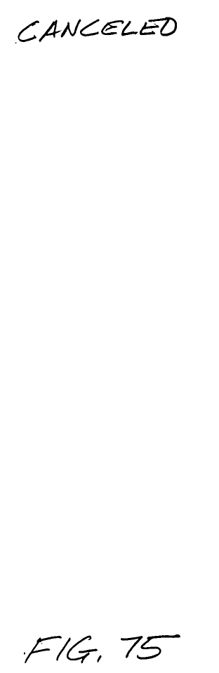

FIG. 76 is cancelled;

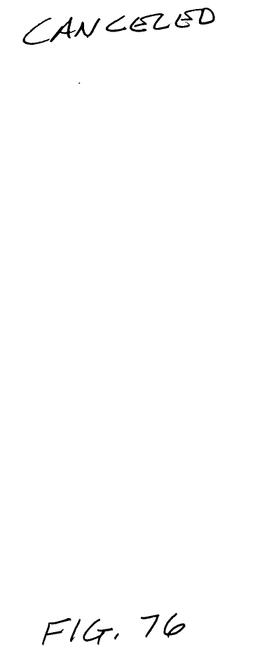

FIG. 77 is cancelled;

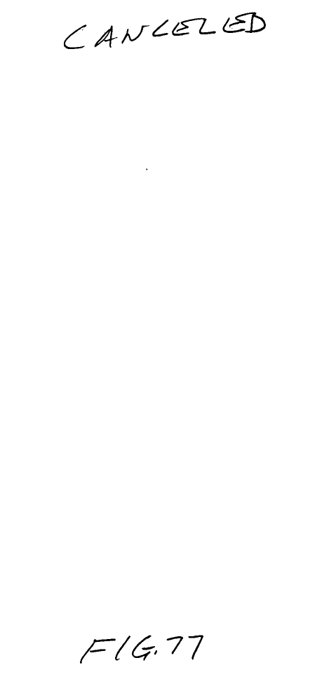

FIG. 78 is a schematic view of a flexible barrier with an elastic opening; and

FIG. 79 is an enlarged view of a typical hollow stem and nozzles.

### DETAILED DESCRIPTION OF THE INVENTION

With reference to the drawings in which a key embodiment of the animal cleaner apparatus according to the invention 10 are shown.

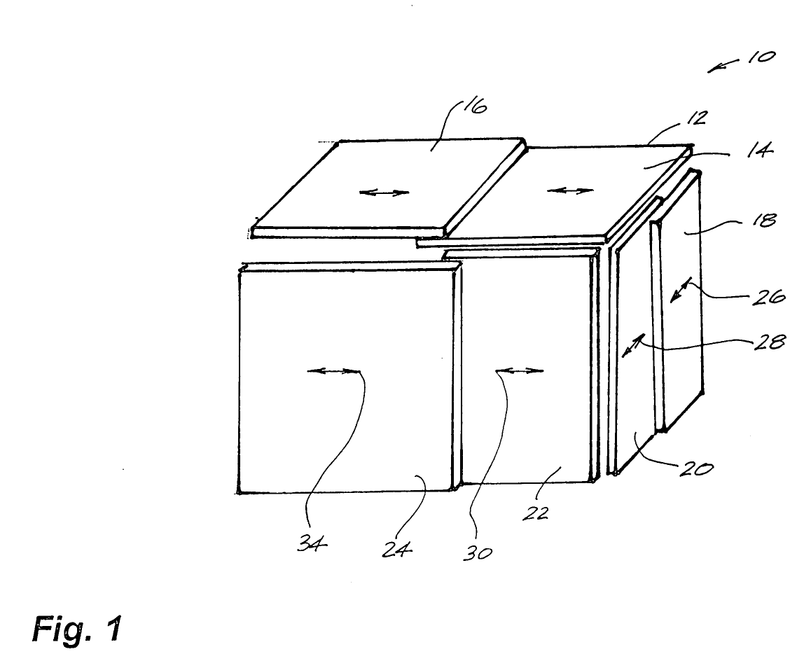

As shown in FIG. 1, the apparatus 10 includes an enclosure 12 which has a plurality of sliding panels 14, 16, 18, 20, 22, 24 which are supported on internally mounted tracks. The panels 14, 16, 18, 20, 22, 24 are tightly fitted thereby making the enclosure 12 sound proof. The panels 14, 16, 18, 20, 22, 24 are preferably transparent and removable and can slide in the directions shown by the arrows 26, 28, 30, 34 in FIG. 1. The importance of the sound proof construction of the enclosure 12 will be explained presently.

The soundproof nature of the enclosure 12 prevents the cat or other animal from hearing the vacuum 122 and blower 120 and becoming frightened and refusing to enter or reenter the apparatus 10.

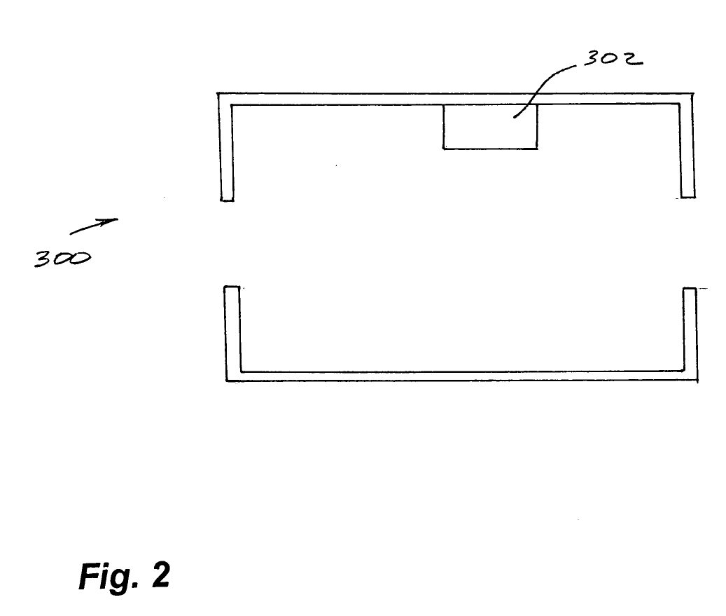

FIG. 2 shows an automatic light unit which has a light 302 which goes on when a heat sensor detects an animal.

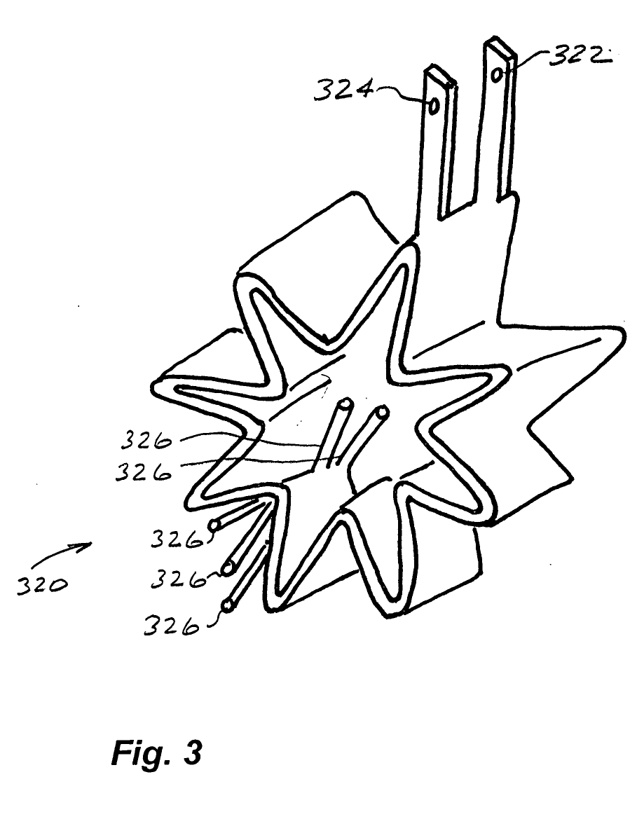

FIG. 3 is a molded rubber unit 320 which has snaps 322, 324 which snap together to hold onto fabric. Bristles 326 are typically located on the inner and outer vertices. The bristles point in all directions.

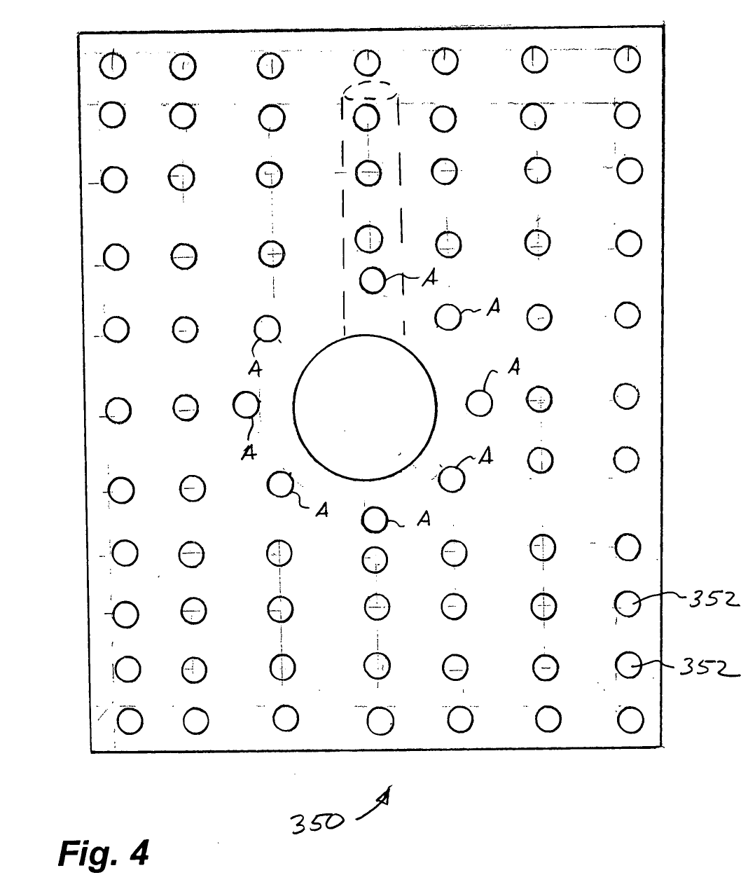

FIG. 4 is a non-tearable sheet 350 which has a plurality of eyelet holes typically designated as 352 and in which the holes designated by the letter A match the location of the snaps in FIG. 3. The eyelet holes facilitate attachment to a frame. The fabric may be folded to adjust the height.

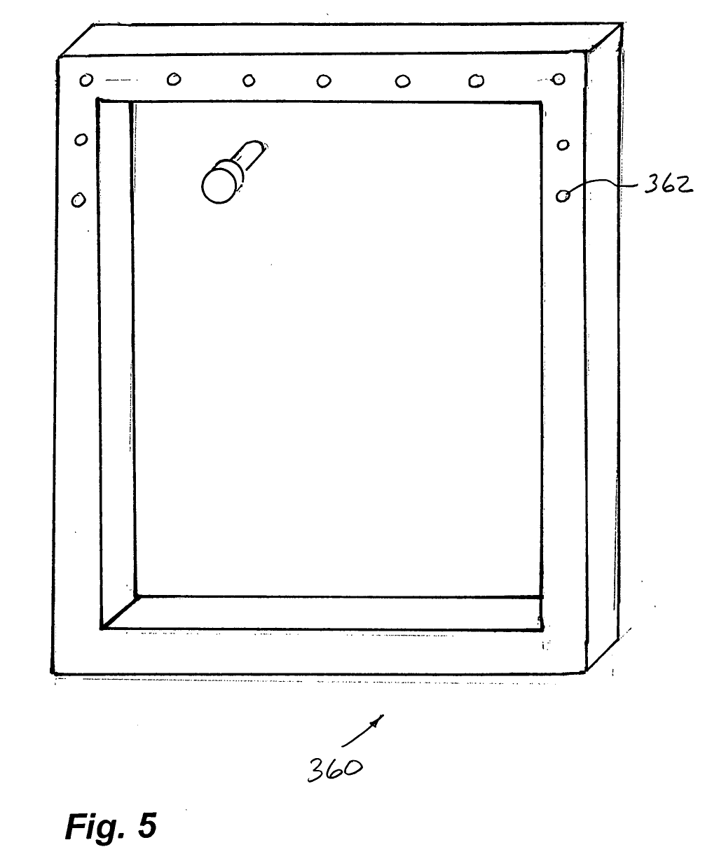

FIG. 5 shows a frame 360 with threaded holes typically designated by the numeral 362.

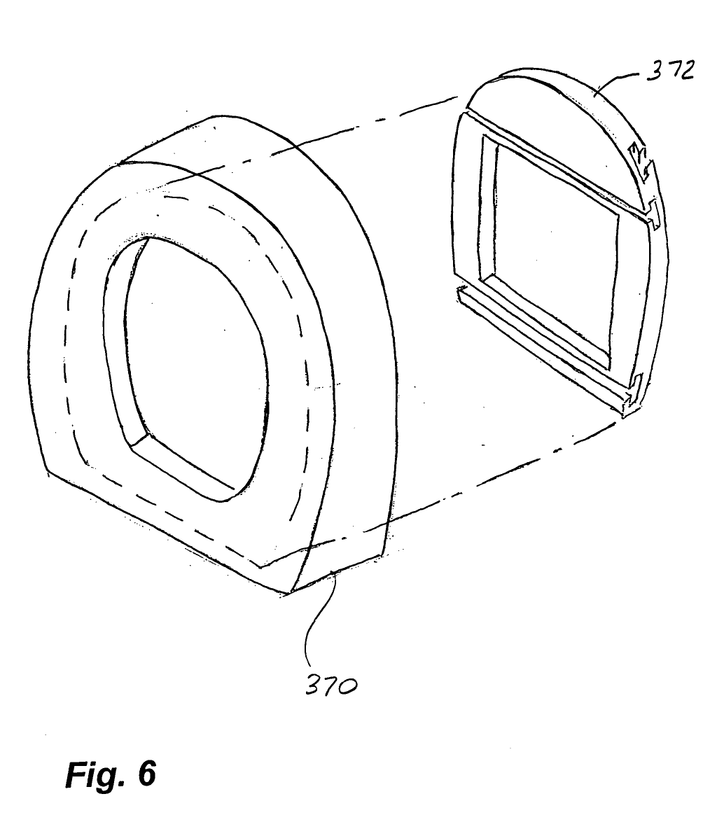

FIG. 6 shows a front cover 370 of an enclosure and a frame 372.

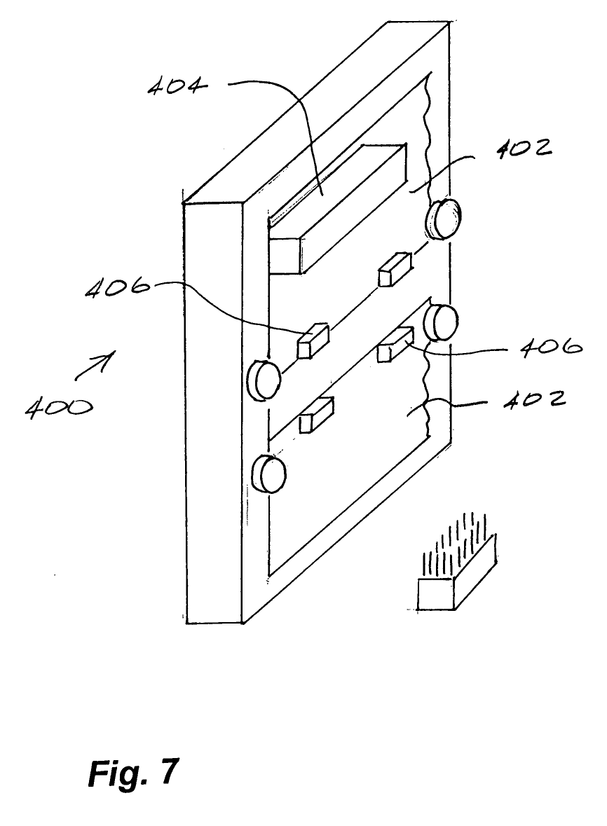

FIG. 7 shows a frame 400 with stretchable electrostatic shades 402 which has a charcoal filter 404, magnets 406 which can hold brushes 408. The shade material 402 is made of loop material which is stretchable and which can be locked in place.

The shade material 402 is electrostatically charged to catch cat hair. The shades 402 can be closed using the magnets.

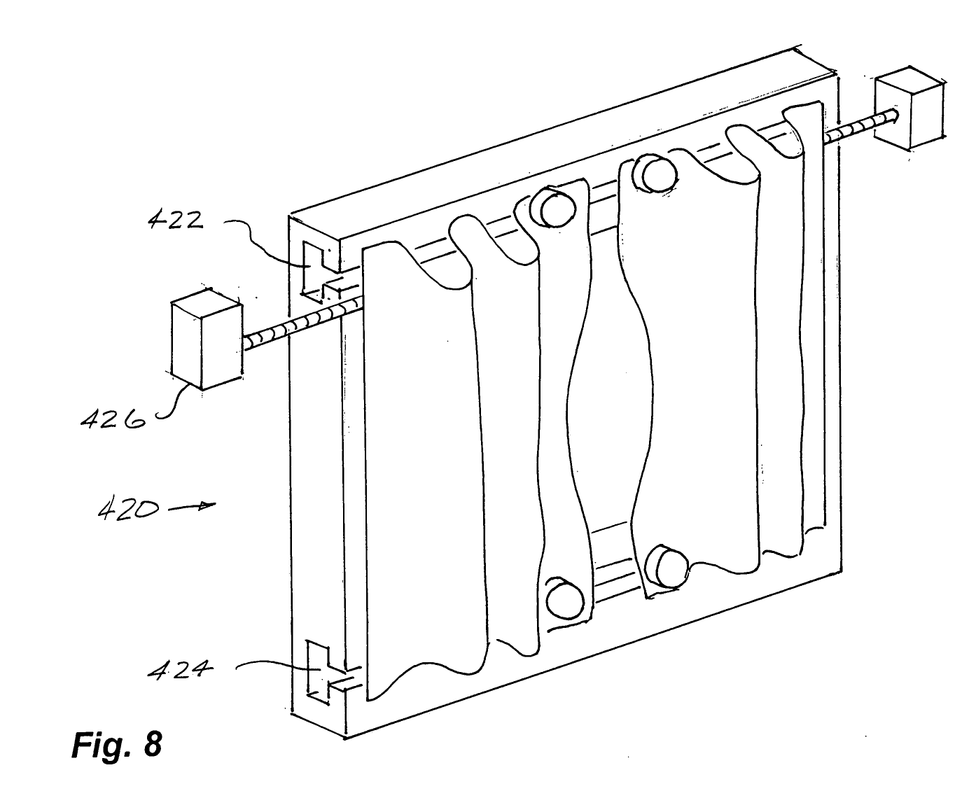

FIG. 8 shows frame 420 with motorized curtains. The frame 420 has slots 422, 424, and is motorized and under the control of a timer 426.

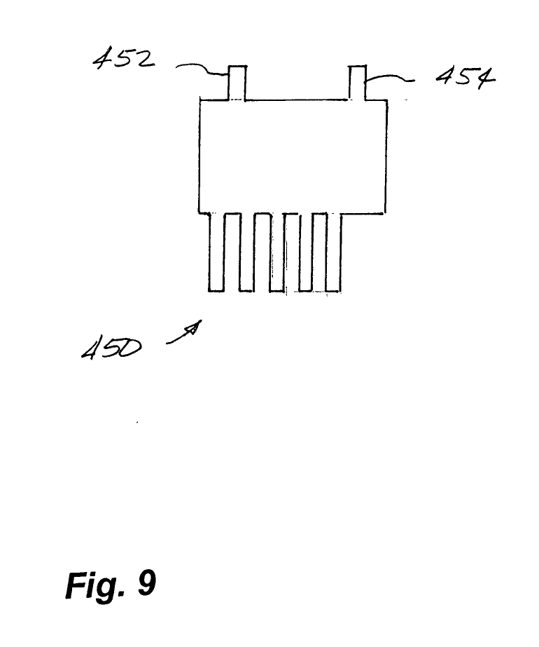

FIG. 9 is a hanging flea zapper 450 which has hooks 452, 454 which can hang suspended from a track.

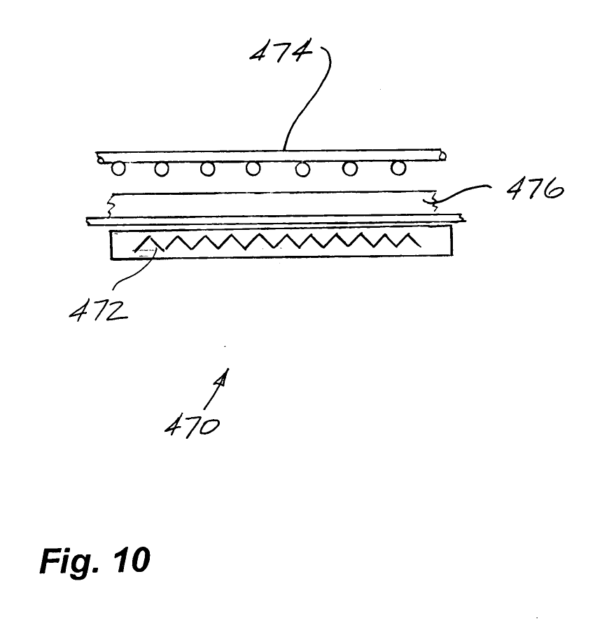

FIG. 10 shows a carpet with a wax layer 470 which includes a heater 472, a screen 474 which allows a cat's nails to contact a layer of soft wax 476 which has been heated by the heater 472. The heater 472 maintains the wax 476 in a soft state and the wax 476 hardens on the cat's nails when the wax cools.

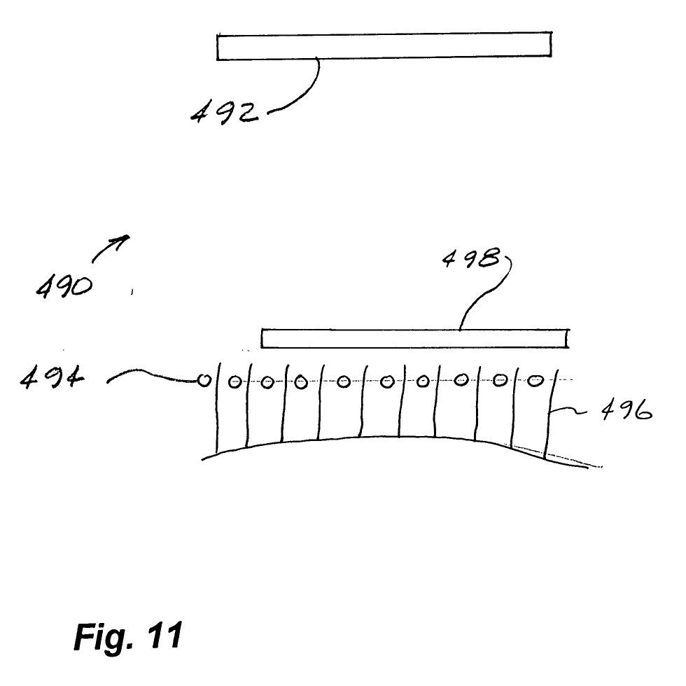

FIG. 11 is a hair singe device 490 which includes a static electric generator 492 which attracts hair 496 and a comb 494. A single loose hair 498 is shown.

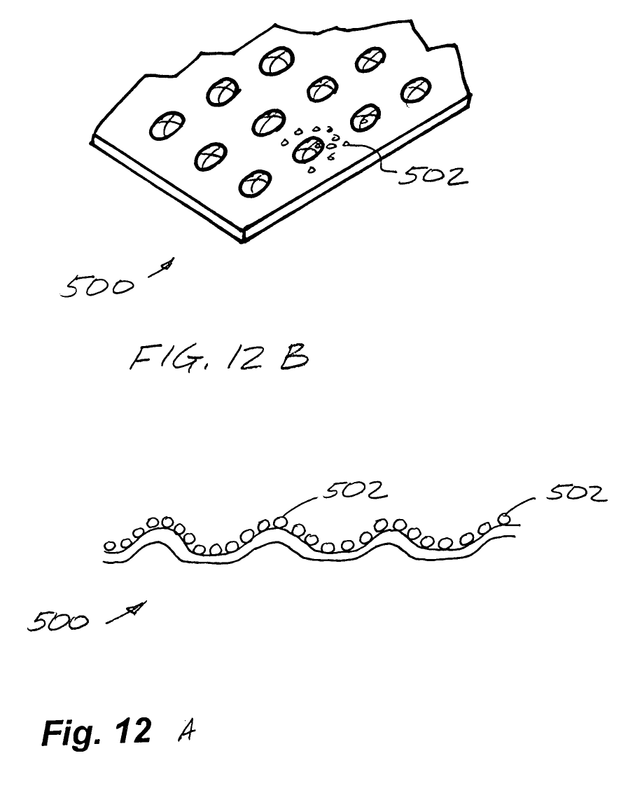

FIGS. 12A and 12B show a nail groomer 500 in which sand particles 502, which are disposed on a base 504, groom a cat's nails.

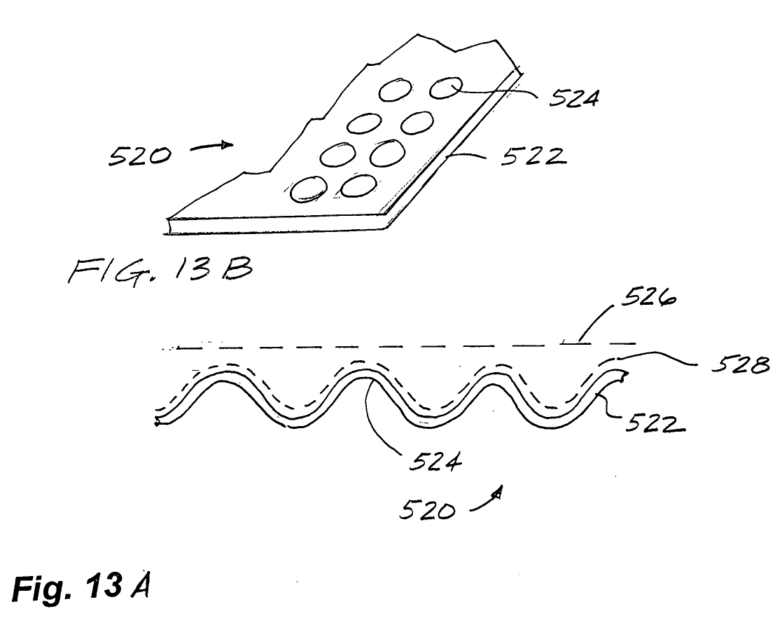

FIGS. 13A and 13B show a nail filer 520 which includes a layer 522 which has a plurality of bumps 524. The cloth or screen 526 is spaced apart from the layer 522. The layer 522 is covered with sandpaper which functions as a nail filer.

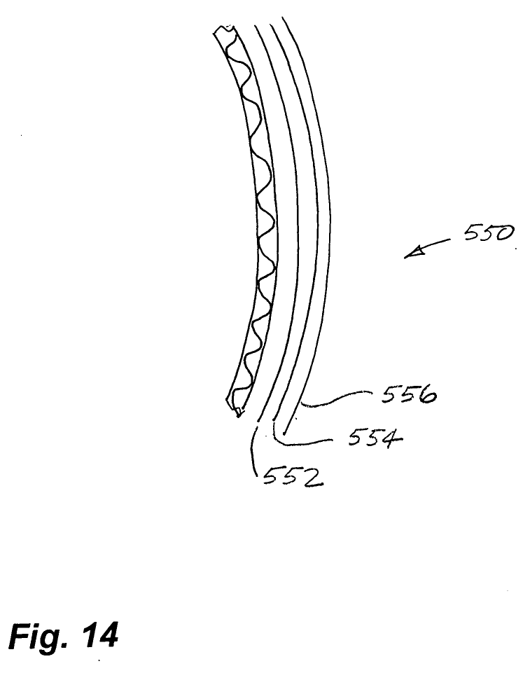

FIG. 14 shows a lint remover brush 550 which includes a plurality of removable adhesive layers 552, 554, 556, each having an adhesive coating.

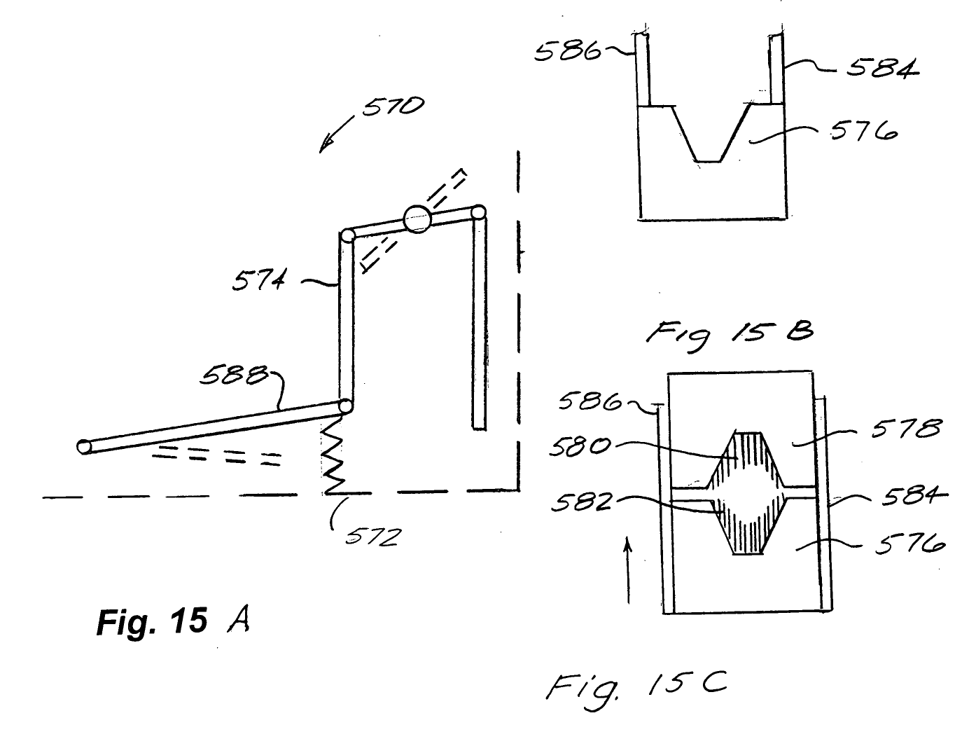

FIGS. 15A, 15B and 15C show a tail brush apparatus 570 which includes an enclosure 572 and a mechanism 574 which is operated by the weight of an animal, resting or sleeping, on a treadle 588, to close a pair of elastic rubber sheets 576, 578 having bristles 580, 582 onto the tail of the animal. The rubber sheets ride in tracks 584, 586.

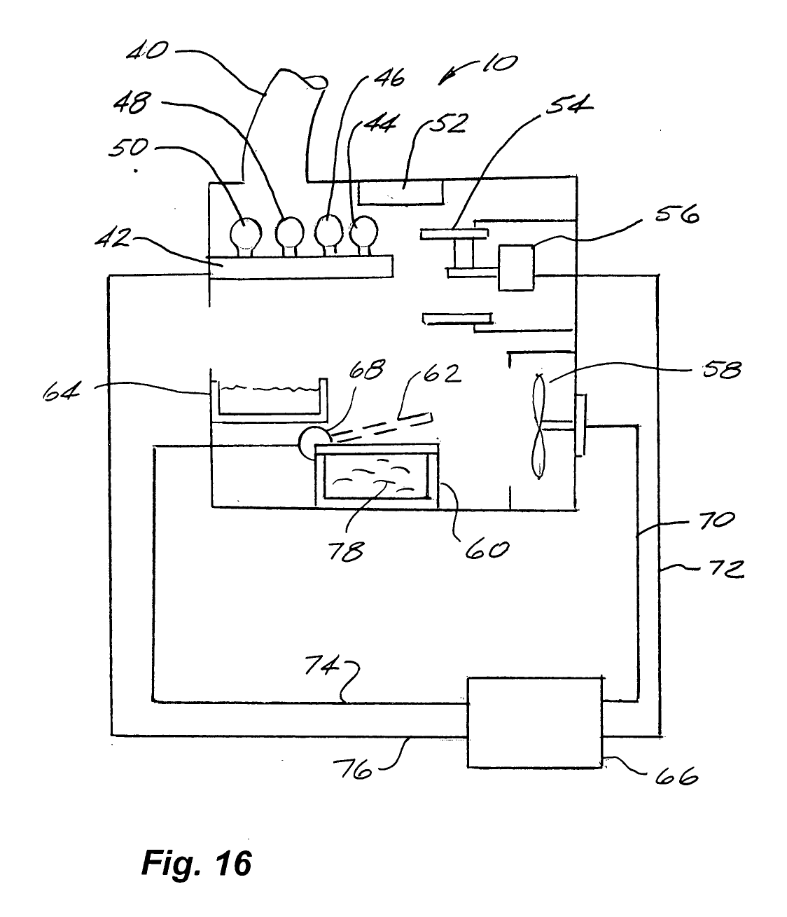

FIG. 16 is a schematic view of the internal components of the apparatus 10 of FIG. 1. The internal components of the apparatus 10 include: a flexible and bendable exhaust tube 40, a light bar 42 which has a plurality of flashing bulbs 44, 46, 48, 50, preferably in a range of colors, a high and low frequency sound source 52, a rotating tube 54 which can be rotated by an electric motor 56, a blower 58, a food container 60 with a controllable lid 62, a container for catnip or chemicals 64, and an electrically operated controller 66.

The controller 66 is connected to the rotating tube 54 for generating sounds, the blower 58, the electric motor drive actuator 68 which controls the food container lid 62, and the light bar 42 by electrical connections 70, 72, 74, 76.

The controller 66 is programmable for automatic operation and can also be turned on and off by a series of photocells mounted in the enclosure 12.

The food container 60 has an internal heater which can maintain the food 78 in the container 60 at optimum temperatures.

The flashing bulbs 44, 46, 48, 50 covering the full visible spectrum, sound source 52 covering the entire audible spectrum provide various ways of attracting the animal. In addition, the container 64 may contain a chemical which provides a scent which attracts the animal.

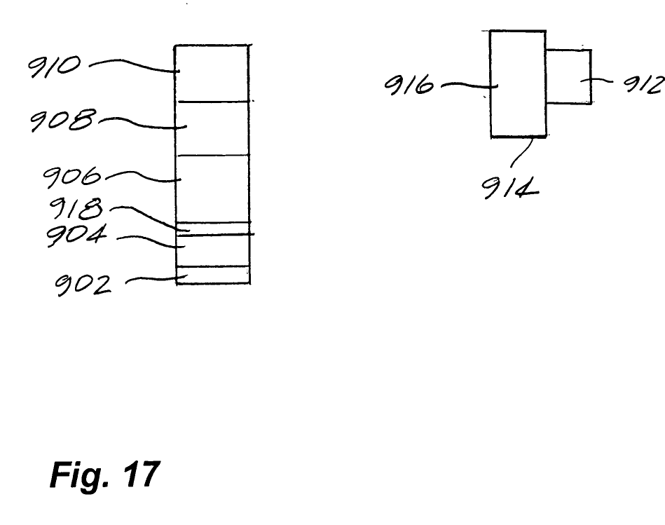

FIG. 17 is transmitter receiver assembly 900 which has an attachment unit 402 for attachment to the collar of an animal, a receiver 904, and microphone 918 which can be turned off 906, a frequency shifter 908, a speaker 910, and a microphone-transmitter unit 912, which includes a microphone 914 and a transmitter 916.

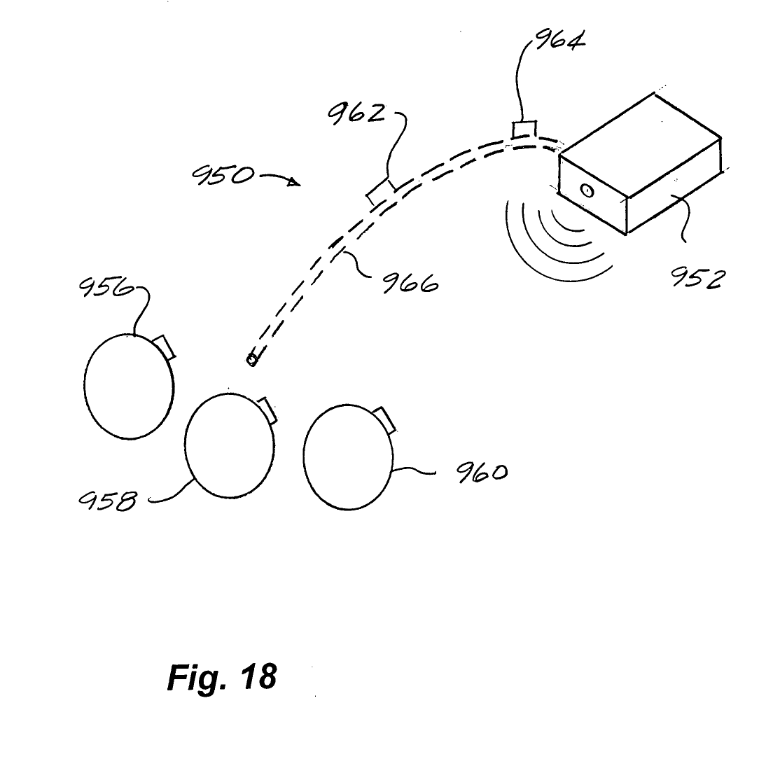

FIG. 18 is a transmitter for an RC harness 950 which includes a transmitter 952 which sends voice commands such as “right,” “left,” “formed,” or “backward” and a receiver 954, which commands and moves controller panels 956, 958, 960. A flashlight 962 and a locator unit 964 may be located on a leash 966. On the leash 966 adjacent to the flashlight 962, there is a hook and loop surface which can be used to mount a radio, a supply of refuse bags on a wallet. The leash 966 may house a wire.

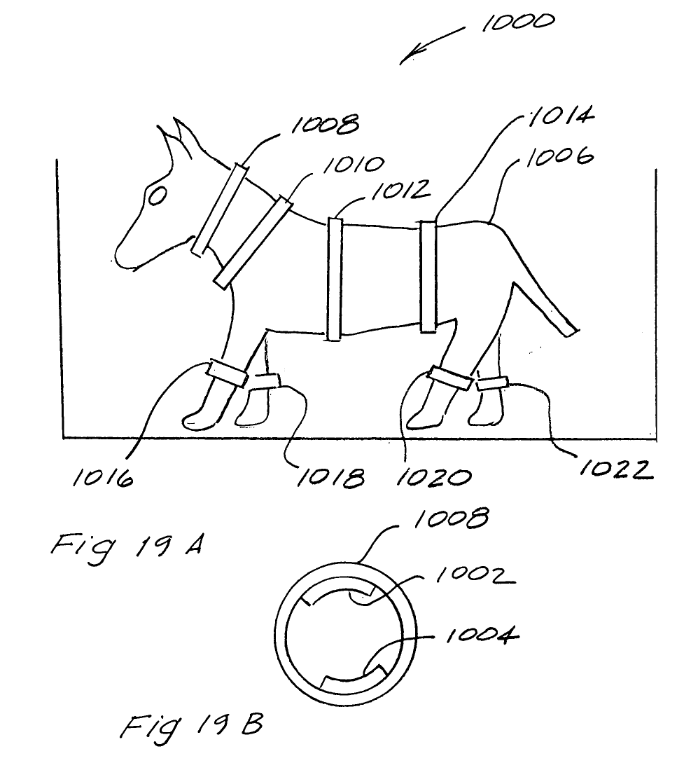

FIGS. 19A and 19B show electrode collar assembly 1000 each of which includes a pair of electrodes 1002, 1004 which can be used to transmit pulses to an animal 1006 in sequential increments to control movement and direction of movement. The assembly 1000 includes individual collars 1008, 1010, 1012, 1014, 1016, 1018, 1020, 1022.

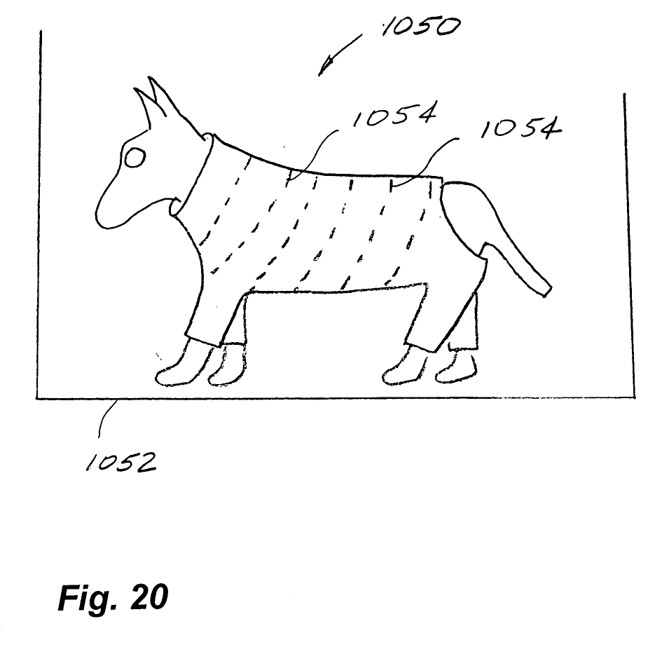

FIG. 20 shows an electrode suit 1050 which includes an enclosure 1052. A plurality of electrodes 1054 in the suit 1050 provides directional signals for an animal wearing the suit 1050.

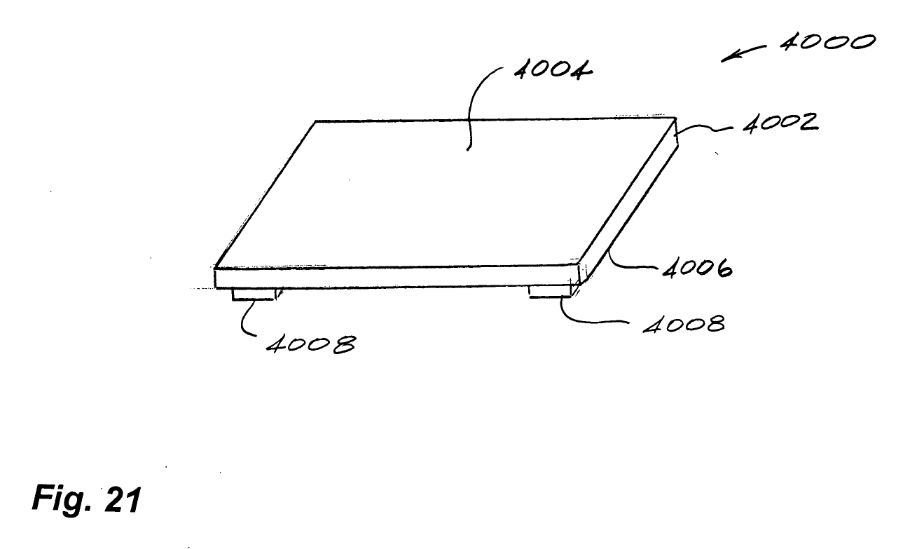

FIG. 21 shows an anti-bacterial sticky carpet 4000. The carpet 4002 has a sticky anti-bacterial material 4004 on the top surface. The bottom surface 4006 has a plurality of hook and loop fastener pads 4008.

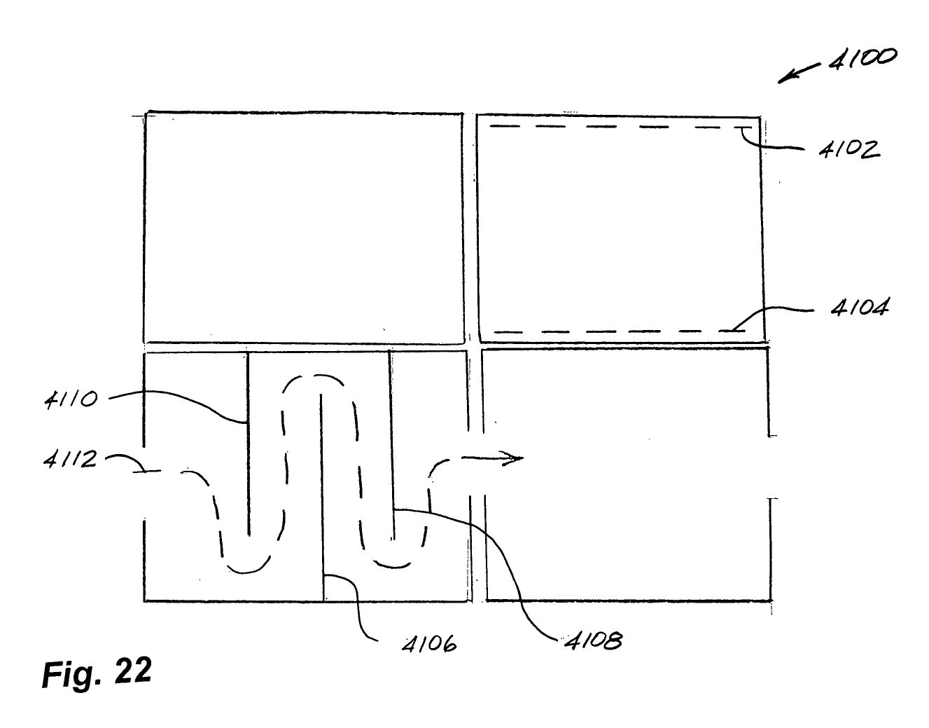

FIG. 22 shows a top view of an enclosure 4100 in which tracks are indicated schematically by the broken lines 4102, 4104. The enclosure 4100 includes an adjustable maze 4106. The path of an animal throughout the maze 4106, 4108, 4110 is indicated schematically by the broken line 4112.

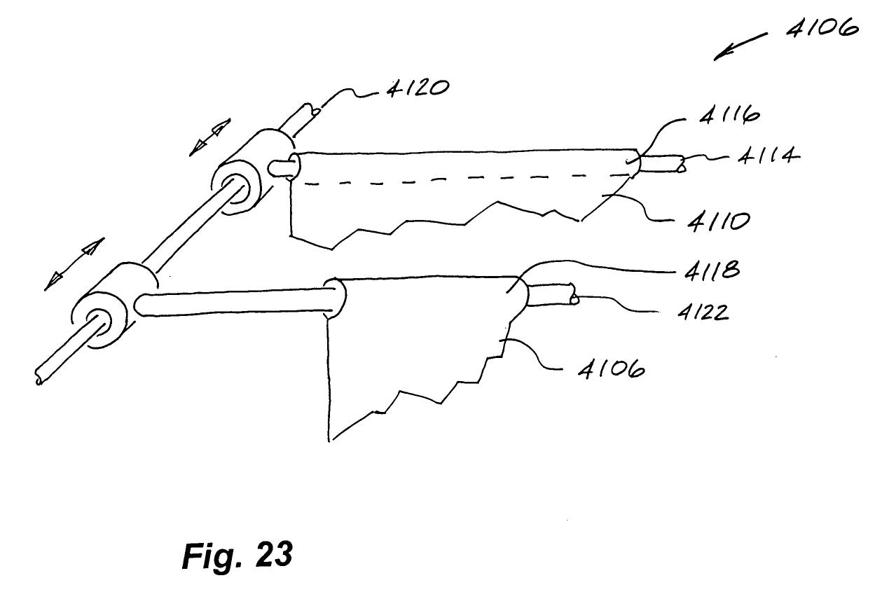

FIG. 23 is a fragmentary perspective view of a portion of the maze 4106, 4110 of FIG. 22 showing rods 4114, 4122 which pass through sleeves 4116, 4118 on the top and on the bottom of the walls 4116, 4110. The position of each of the rods 4114, 4122 is adjustable with respect to the rod 4120.

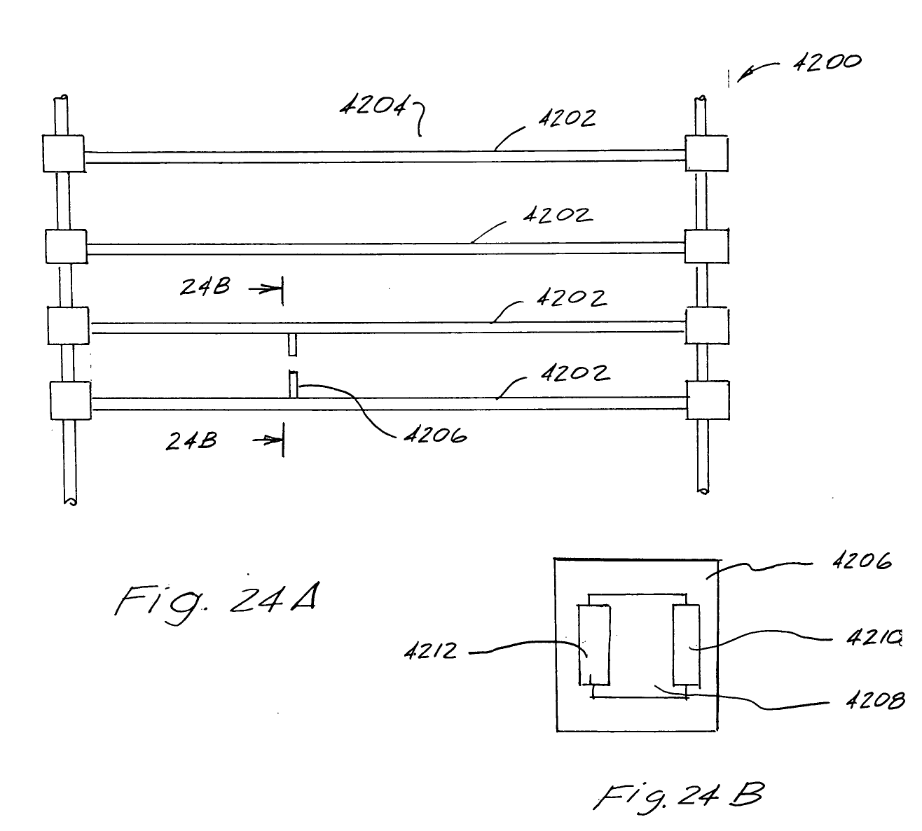

FIG. 24A is a top plan view of an adjustable maze 4200 with fabric walls 420. The walls 4204 are disposed above a carpet which can have a sticky material or sponge surface.

FIG. 24B is an elevation view taken along the line 24B-24B of FIG. 24A showing the opening 4208 in the fabric wall 4206 and showing a pair of hook and loop fastener pads 4210, 4212, which may be used to attach brushes.

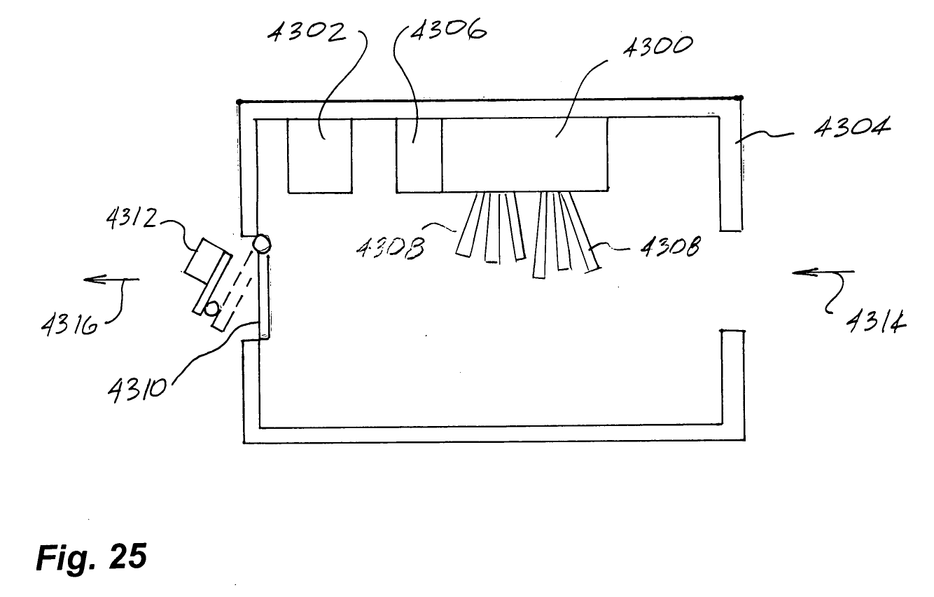

FIG. 25 shows a mist sprayer unit 4300 which includes a heater/cooler/humidifier/dehumidifier unit 4302 which maintains optimum temperature and humidity in the enclosure 4304. A thermal conditioning unit 4306 maintains the temperature of the mist which is in the mist sprayer unit 4300. The mist sprayer unit 4300 sprays mist onto a cat via tubes 4308. The tubes 4308 can be directed to selected areas. The mist sprayer unit 4300 is quiet and goes on responsive to the movement of a door 4310, which actuates a micro switch 4312. The cat moves in the directions shown by arrows 4314, 4316.

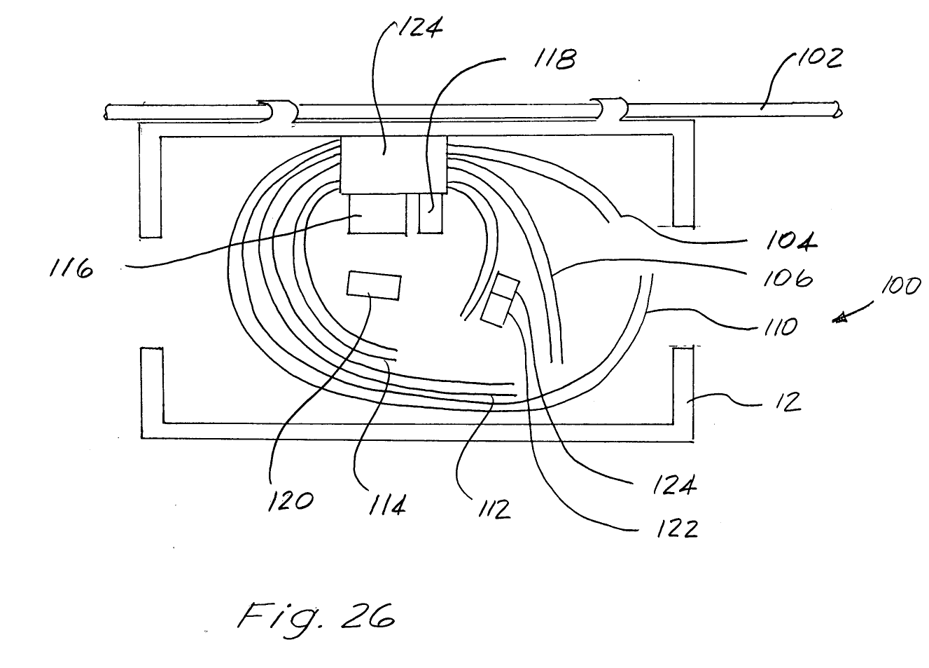

FIG. 26 shows a schematic of the vacuum blower ionizer ultra-violet unit 100 which is mounted inside the enclosure 12 of FIG. 1. The unit is mounted on a track 102 and can be repositioned relative to the walls or panels 14, 16, 18, 20, 22, 24.

The unit 100 has multiple ports and flex ducts 104, 106, 108, 110, 112, 114 which can be directed to all areas of the enclosure 12. The unit includes an air dryer 116, a mist generator 118, a blower 120, a vacuum unit 122, a combination positive ion and negative ion generator and ozone generator 124.

The polarity of the ions generated by the generator 124 can be reversed. The intensity of the blower 120 and vacuum 122 can be controlled.

The intensity of the blower 120 is weaker than the vacuum 122 to ensure removal of all loose hair, dirt particles and debris. The unit 100 cleans an animal in the enclosure 12 and also cleans the interior of the enclosure 12. The loose hair, dirt particles and debris are removed from the animal and from the air and interior walls of the enclosure to prevent this unwanted material from being reapplied to the animal. The application of positive ions, negative ions and ozone provides both interaction between the enclosure and the animal and cleaning of both the animal and the enclosure 12.

The electrostatic treatment of the animal hairs facilitates cleaning down to the roots of the hair.

The electrostatic treatment causes the hair to become erect thereby allowing the removal of dirt with a blower 120 which generates a low level of pressure and consequently, an extremely low level of noise. This prevents the animal from becoming frightened.

The raising of the hair by the electrostatic generator 124 exposes the animal's skin thereby facilitating treatment of the skin by application of ozone, powder, oil, vapor or medication.

The electrostatic generator 124 also attracts and removes dirt, dander, debris and unwanted matter from the animal's hair.

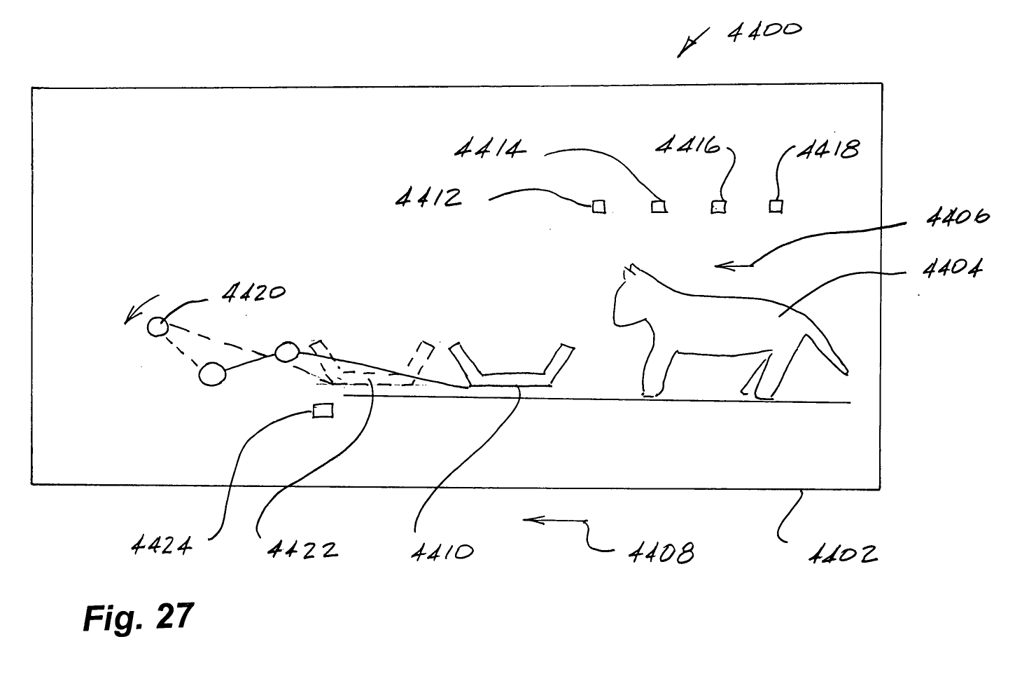

FIG. 27 shows a movable food tray 4400 which is mounted in an enclosure 4402. As the cat 4401 moving in the direction shown by the arrows 4406, 4408 approaches the food tray 4410, the photocells 4412, 4414, 4416, 4418 sense the position of the cat 4404 and the motor 4420 moves the food tray 4410 further in the enclosure 4402 to the position shown in broken lines 4422. When the food tray reaches the position shown by the broken lines 4422, the switch 4424 shuts the motor 4420 off.

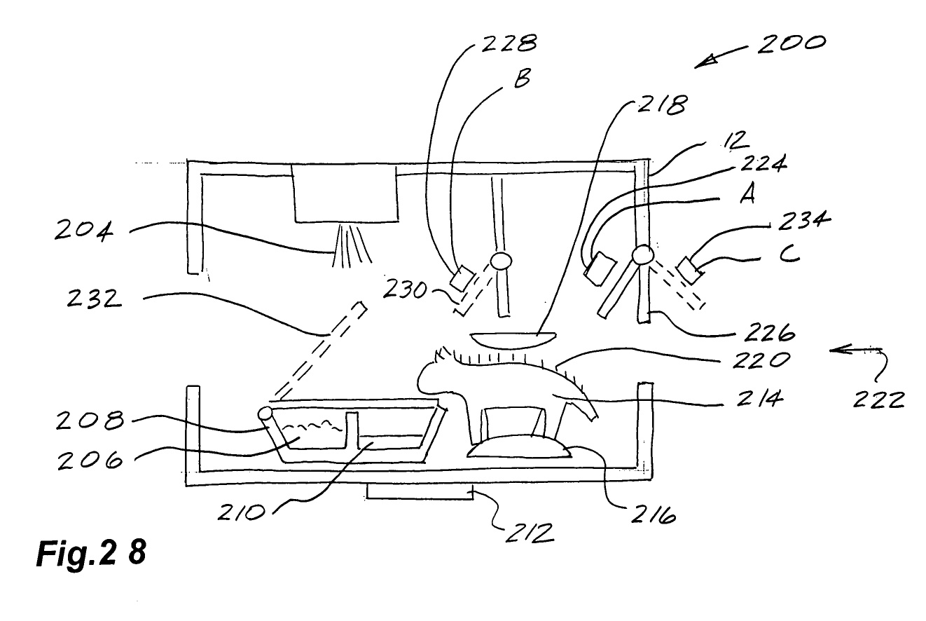

FIG. 28 is a schematic view of a feeder/refrigeration spray unit 200, which includes a sprayer 202 which adds fine spray 204 onto food 206 contained in the food container 208. The food container 208 can contain food 206, water 210, or a snack. A refrigeration unit 212 maintains the food 206 at optimum temperatures.

When the cat 214 steps on the pad 216, a static electricity generator 218 raises the cat hair 220. The cat 214 moves in the direction shown by the arrow 222. A microswitch 224 designated by the Letter A is mounted on the door 226. A microswitch 228 designated by the Letter B is mounted on the door 230. The sprayer 202 operates when the cat 214 enters the enclosure 12 and switch A 224 closes. The lid 232 covering the food container 208 opens when switch A 224 closes. The lid 232 closes when switch C 234 closes. This arrangement enables the apparatus 10 to operate when the cat 214 is in the proper position.

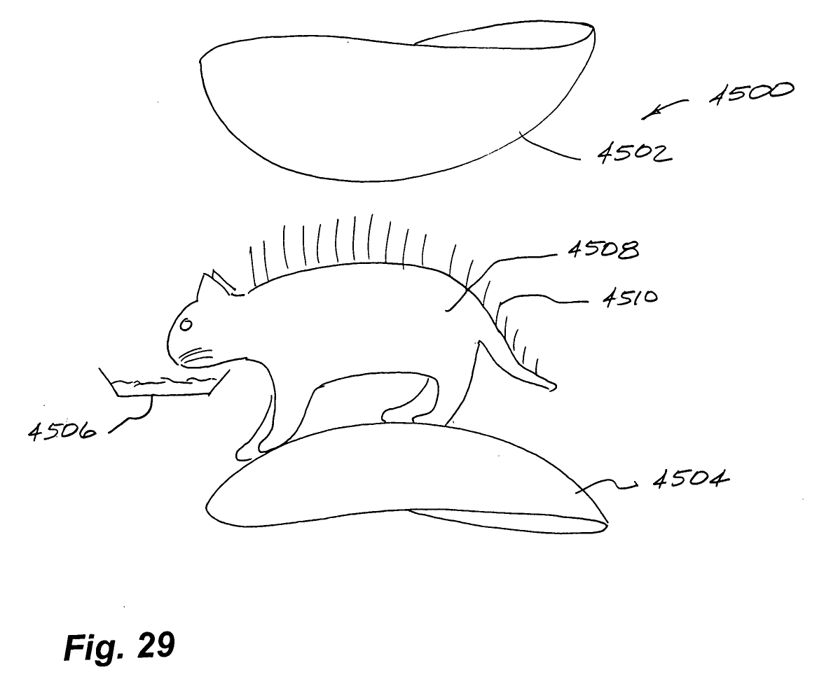

FIG. 29 shows a static electricity generator 4500 which includes a pair of domes 4502, 4504. A feeder tray 4506 is disposed between the domes 4502, 4504 and when the cat 4508 steps on the lower dome 4504 to reach the feeder tray 4506, the cat's hair 4510 is attracted to the upper dome 4502.

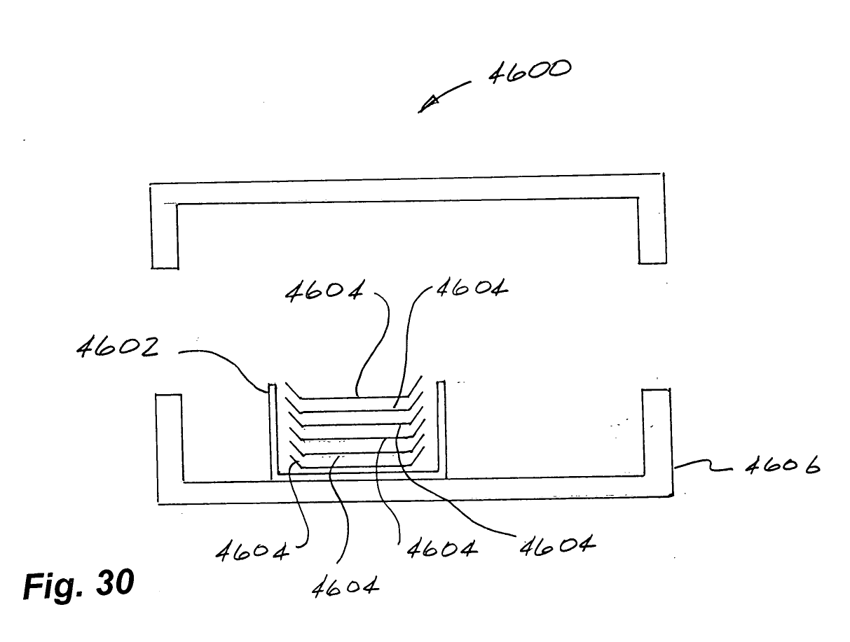

FIG. 30 shows a stack tray feeder 4600 which includes a stack 4602 of nested trays 4604. Each of the trays 4604 is disposable. The feeder 4600 is mounted in an enclosure 4606.

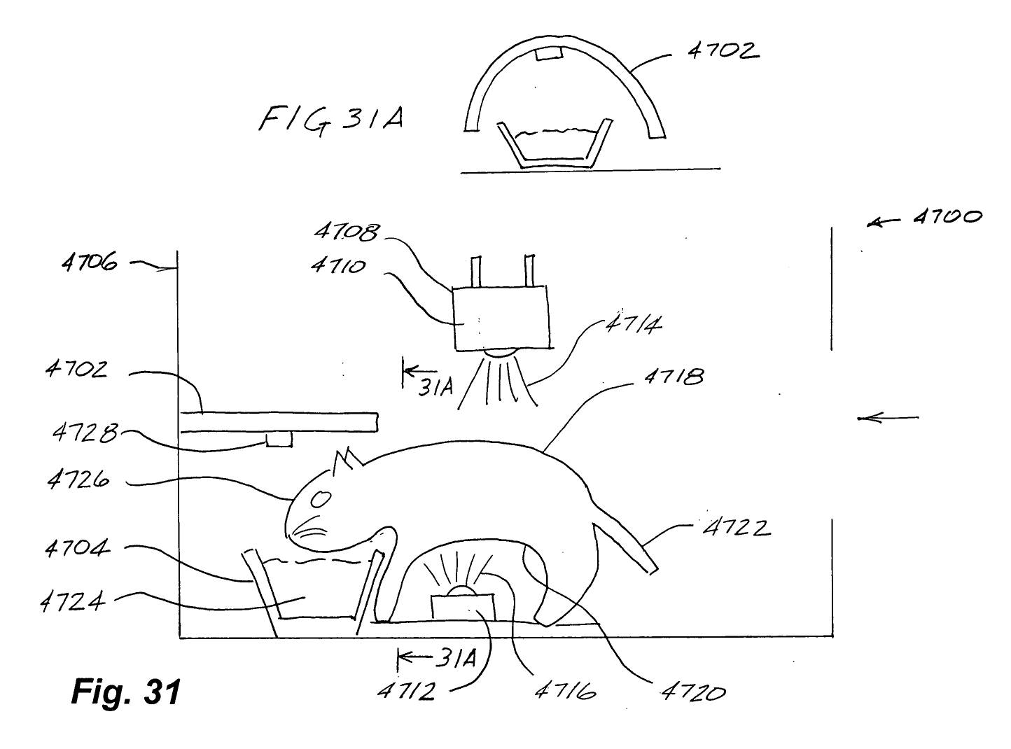

FIGS. 31 and 31A show a hooded feeder unit 4700 which includes a curved hood 4702 which is disposed above a feeding tray 4704. The unit 4700 is mounted in an enclosure 4706. A sprayer unit 4708 includes a pair of spray dispensers 4710, 4712 which dispense a spray stream 4714, 4716 on the top 4718 and on the bottom 4720 of the cat 4722. To reach the food 4724, the cat 4722 places its head 4726 under the hood 4702 thereby actuating a photocell 4728 which turns the sprayer unit 4708 on. The hood 4702 prevents the sprayer unit 4708 from coating the head 4726 of the cat 4722.

FIG. 31A is an elevation view taken along the line 31A-31A of FIG. 31 showing the curvature of the hood.

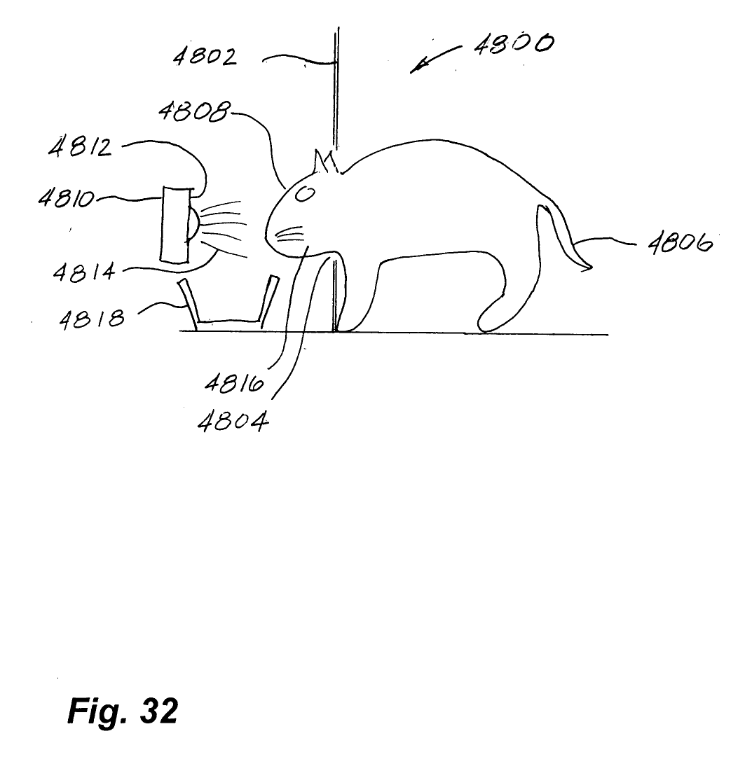

FIG. 32 is a body shield sprayer feeder 4800 which includes a shield 4802 having an aperture 4804. The aperture 4804 allows the cat 4806 to push its head 4808 through the aperture 4804. The sprayer 4810 is under the control of a photo electric beam 4812 and applies a spray treatment 4814 to the cat's head 4816, sprayer feeder 4800 includes a food tray 4818.

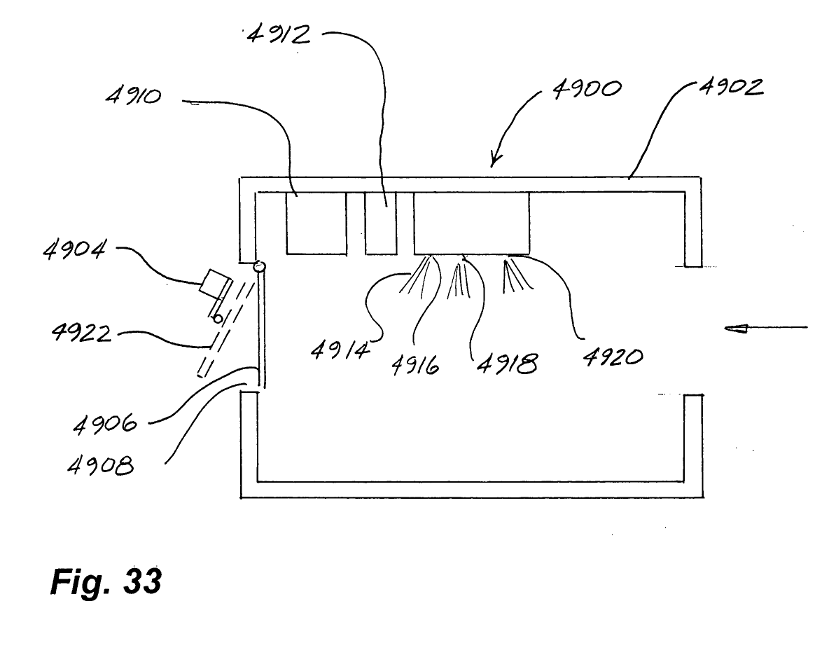

FIG. 33 shows a mist sprayer unit 4900 which is mounted in an enclosure 4902. The sprayer unit 4900 is activated by a micro switch 4904 mounted on a door 4906 which is mounted on an aperture 4908 formed in the enclosure 4902. The unit 4900 includes a heater/cooler/humidifier/dehumidifier unit 4910 which maintains an optimum temperature and humidity in the enclosure 4902. The unit 4900 also includes a thermal conditioning heater/cooler 4912 which maintains the mist 4914 at an optimum temperature. The sprayer unit 4900 sprays mist onto an animal in the enclosure 4902. The mist 4914 flows through tubes 4916, 4918, 4920 which can be directed to selected areas. The mist sprayer 4900 is quiet and goes on when the door 4906 is opened as indicated by the broken lines 4922.

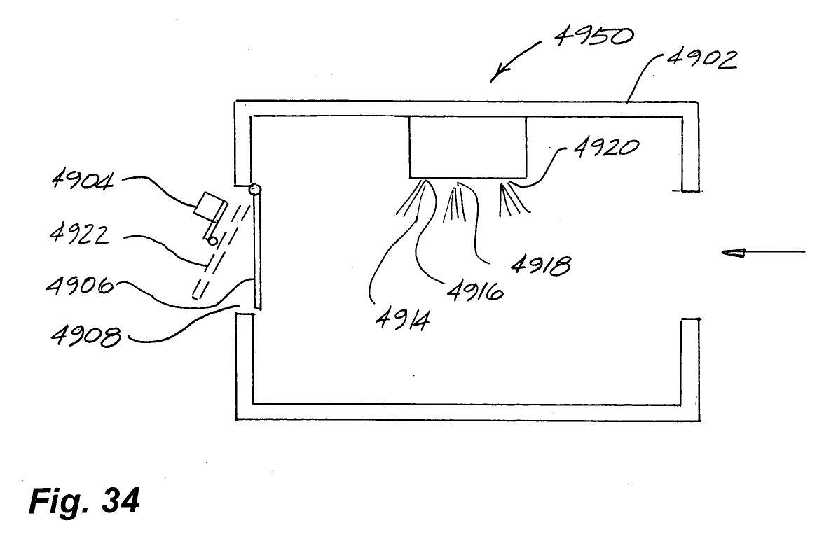

FIG. 34 shows a mist sprayer unit 4950 which is identical to the mist sprayer unit 4900 previously described with the exception that the heater/cooler/humidifier/dehumidifier unit 4910 has been eliminated. In addition, the thermal conditioning heater/cooler 4912 has been eliminated.

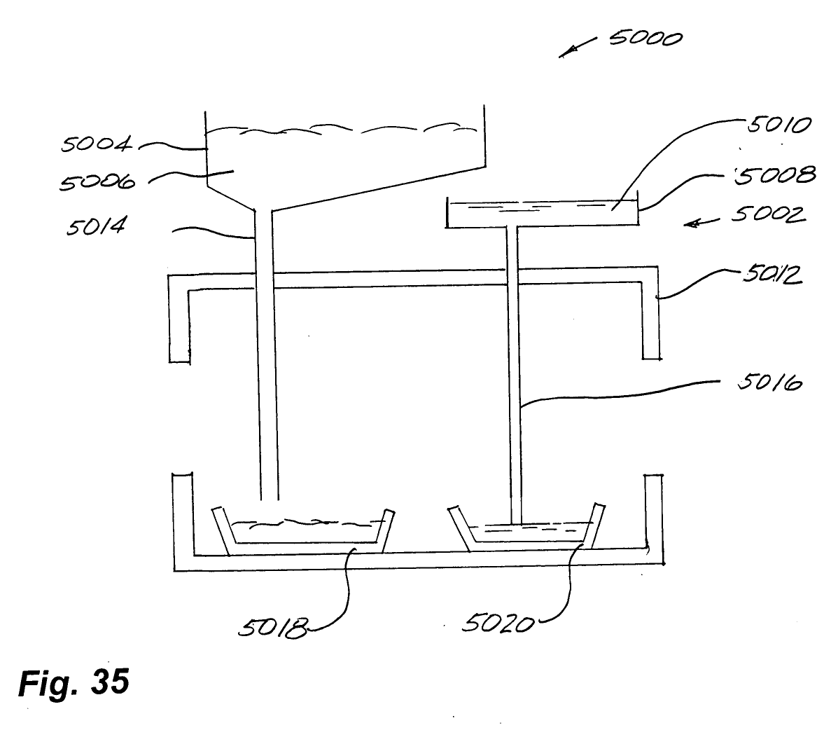

FIG. 35 shows a feeder 5000 with a top loading duct supply 5002 which includes a relatively large supply bin 5004 which holds a relatively large supply of dry food 5006 and a relatively large tank 5008 which holds a relatively large supply of water 5010. The supply bin 5004 and the tank 5008 are disposed above an enclosure 5012. Ducts 5014, 5016 transfer the dry food 5006 to a feeder 5018 which is disposed inside the enclosure 5012 and transfer the water 5010 from the tank 5008 to a feeding dish 5020 which is also disposed in the enclosure 5012.

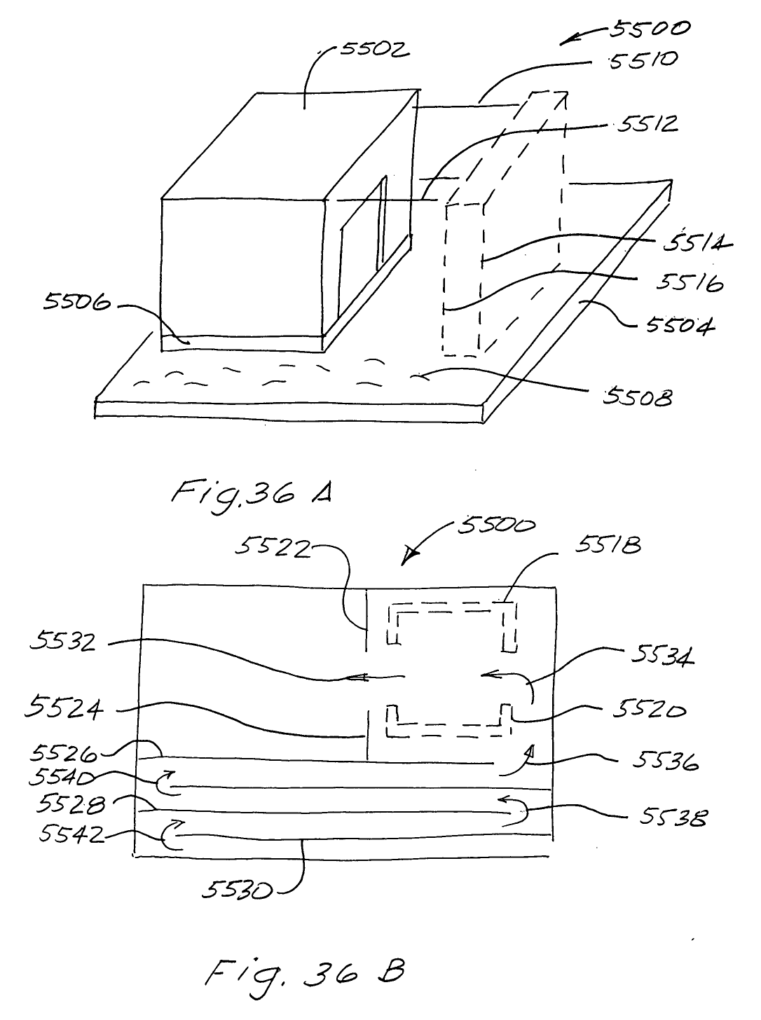

FIG. 36A shows a perspective view of litter box maze 5500 which includes an enclosure 5502 which is mounted on a support 5504 using a hook and loop fastener 5506. A layer of sticky material 5508 on the support 5504 removes dirt from the paws of an animal. Wire support members 5510, 5512 support flexible walls 5514, 5516 in the enclosure 5502.

FIG. 36B shows a schematic cross-sectional plan view which shows the maze 5500 which has flexible walls 5518, 5520, 5522, 5524, 5526, 5528, 5530. The path of an animal through the maze is shown by the arrows 5532, 5534, 5536, 5538, 5540, 5542.

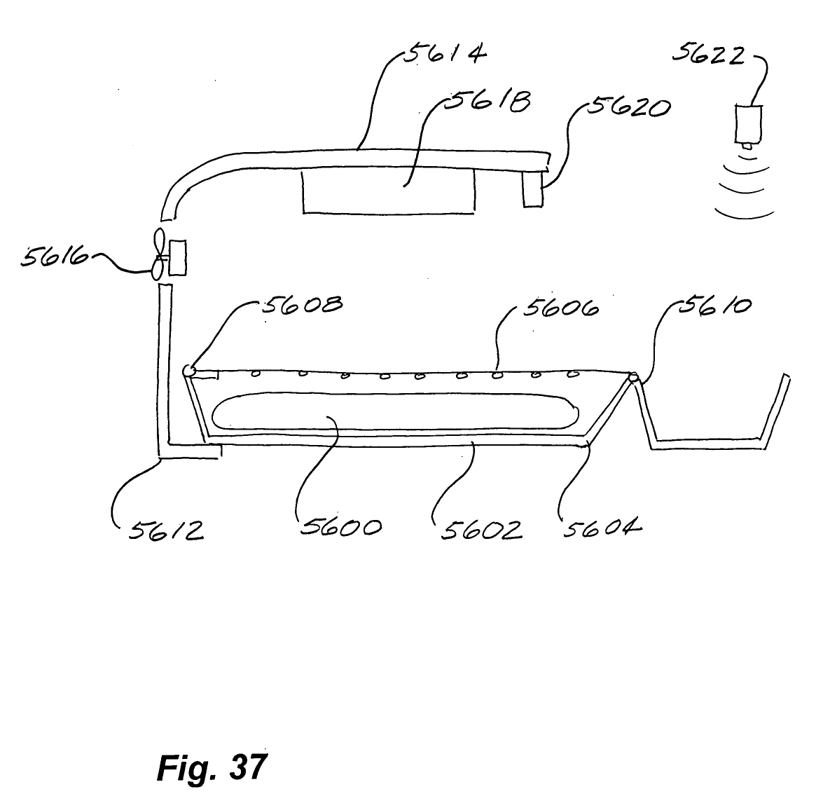

FIG. 37 shows a wee-wee pad 5600 with a screened litter box 5602. The wee-wee pad 5600 is disposed in a wee-wee tray 5604 which is covered by a screen 5606. The screen 5606 is attached to the tray 5604 by a hinge 5608. A food tray 5610 is disposed adjacent to the wee-wee tray 5604. The wee-wee tray 5604 and the food tray 5610 are disposed in an enclosure 5612 which includes a hood 5614 which has a fan 5616 and a charcoal filter 5618. A chemical drip unit 5620 which dispenses a dog attracting fluid is controlled by a photo cell 5622.

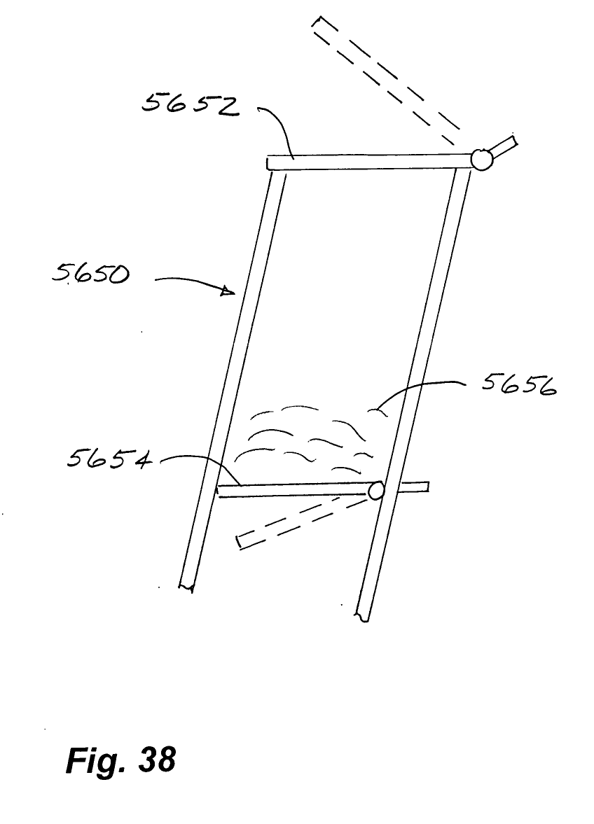

FIG. 38 shows a food chute 5650 which includes an upper door 5652 and a lower door 5654. The upper door 5652 is opened to drop litter 5656 into the chute 5650. The lower door 5654 is opened to drop litter 5656 into a box (not illustrated). The chute 5650 and the doors 5652, 5654 present odors from escaping from the chute 5650.

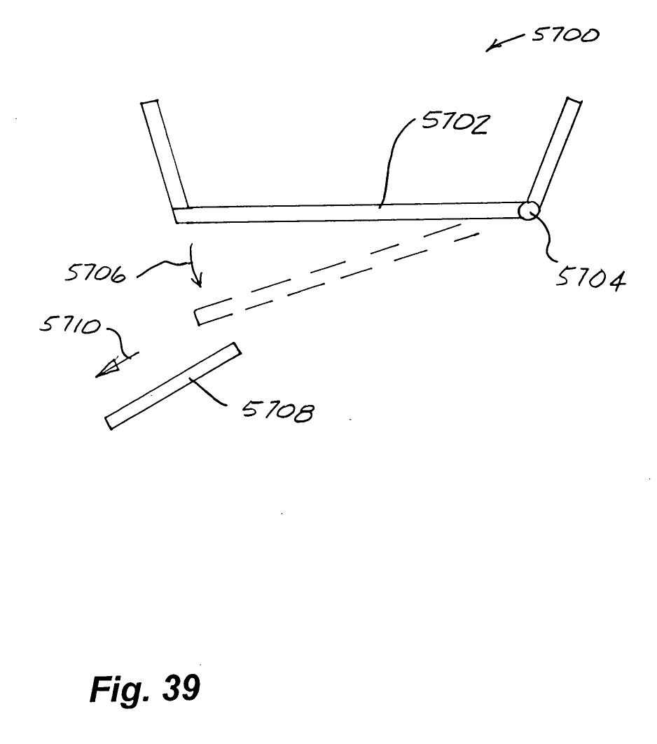

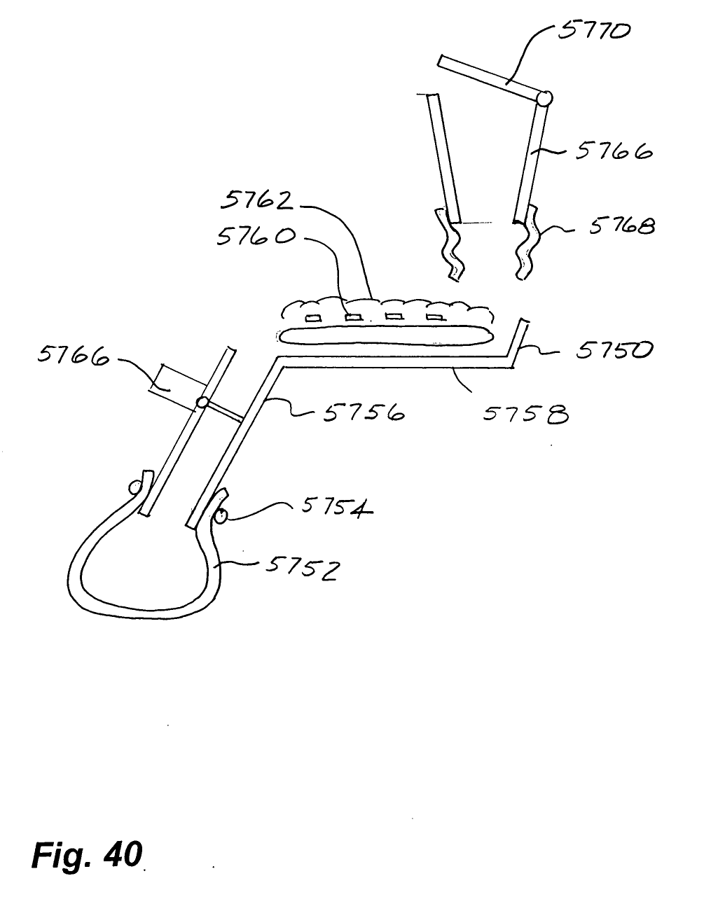

FIG. 39 shows a litter box 5700 with a bottom door 5702. The door 5702 has a hinge 5704 and opens in the direction shown by the arrow 5706 to dump litter from the litter box 5700 onto a chute 5708 in the direction shown by the arrow 5710. The bottom of the chute has a bag 5752 with a rubber band 5754 closure (shown in FIG. 40) which receives the litter from the chute 5708. The chute 5708 may be flexible.

FIG. 40 shows a litter tray 5750 with a waste duct 5756 which includes a tray 5758 with a comb 5760 to rake waste 5762 into the duct 5756 which is mounted adjacent to the tray 5750. An intermediate portion of the duct 5756 includes a control valve 5766. The duct leads 5756 to a bag 5754 which collects the waste. The bag 5754 includes a rubber band 5754 which connects the bag 5754 to the duct 5756. A supply duct 5766 is disposed above the tray 5750 and includes a flexible portion 5768 and a door 5770. The supply duct 5766 deposits litter into the tray 5750.

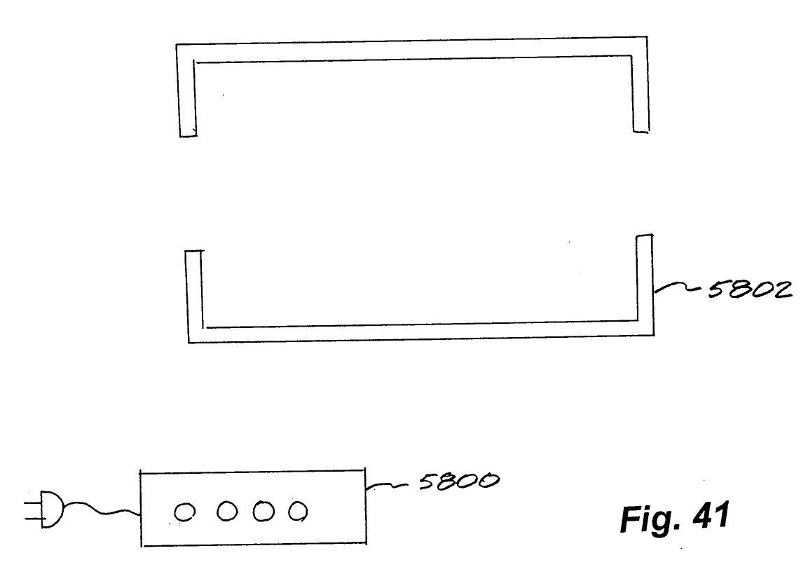

FIG. 41 shows a control unit 5800 which controls the operation of a plurality of units which are mounted in an enclosure 5802. The enclosure 5802 has a framework of tracks and has provisions for ducts and electrical power.

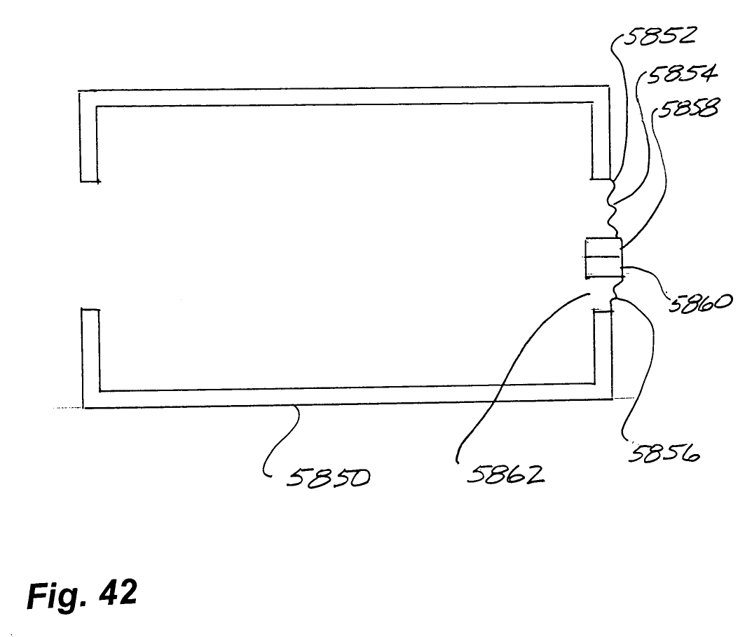

FIG. 42 shows an enclosure 5850 with a stretchable curtain switch 5852 which includes fabric portions 5854, 5856 and magnets 5858, 5860. The magnets 5858, 5860 form a closure between the portions of fabric 5854, 5856. The magnets 5858, 5860 may act as a switch. The fabric portions 5854, 5856 and the magnets 5858, 5860 close an aperture 5862 in the enclosure 5850.

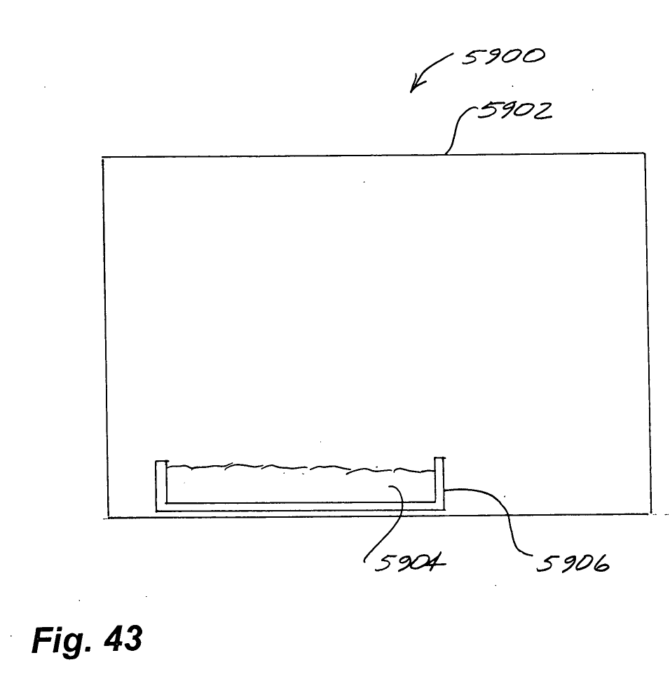

FIG. 43 shows a charcoal odor absorber 5900 which is disposed in an enclosure 5902. Charcoal 5904 which is disposed in a tray 5906 keeps the air in the enclosure 5902 fresh.

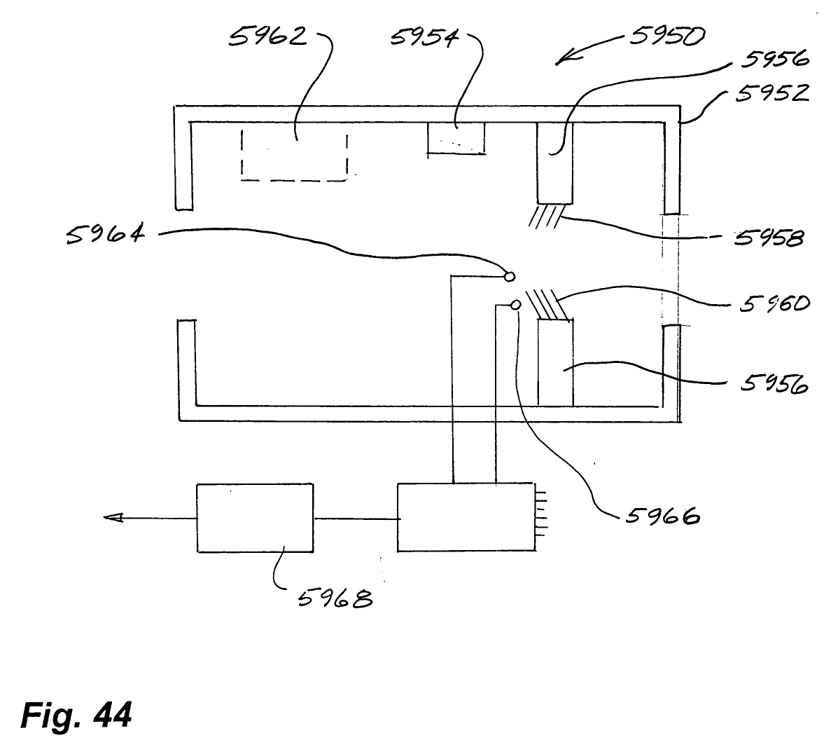

FIG. 44 shows a cleaner with bendable tubes 5950 which includes an enclosure 5952, a heat sensor 5954, a vacuum cleaner/blower/ionizer/u-v unit 5956 which can be attached to tracks on the enclosure 5952. The unit 5956 has multiple flexible ports or tubes 5958, 5960 which can be directed to all areas of the enclosure 5952. The cleaner 5950 also includes a timer 5952, a positively-charged blower outlet ring 5964 and a negatively charged inlet ring 5966. The unit 5950 goes on when the heat sensor 5968 indicates that a cat is in or near the enclosure 5952.

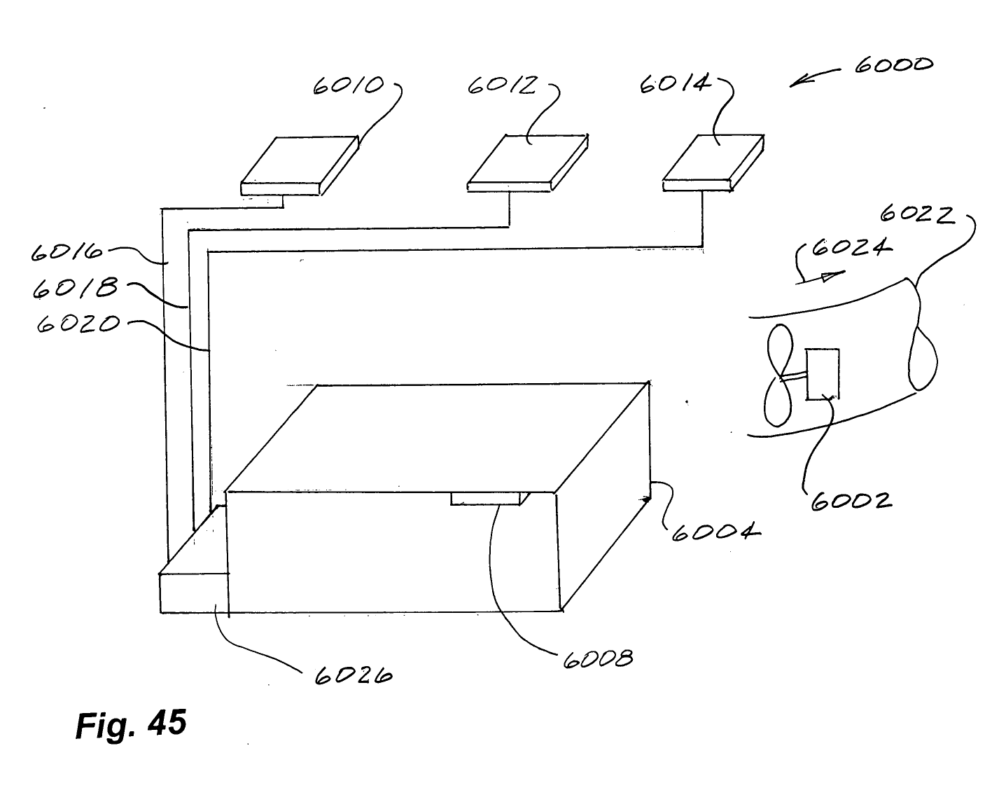

FIG. 45 shows a room environment protector 6000 which includes a blower 6002, a vacuum unit 6004, a positive ion generator 6006, a first ion plate 6008 connected to the positive ion generator 6026, and a plurality of ion plates 6010, 6012, 6014 which are disposed above the first ion plate 6008 and are connected to the ion generator 6026 via a plurality of wires 6016, 6018, 6020. The protector 6000 also includes a duct 6022 which carries air in the direction shown by the arrow 6024.

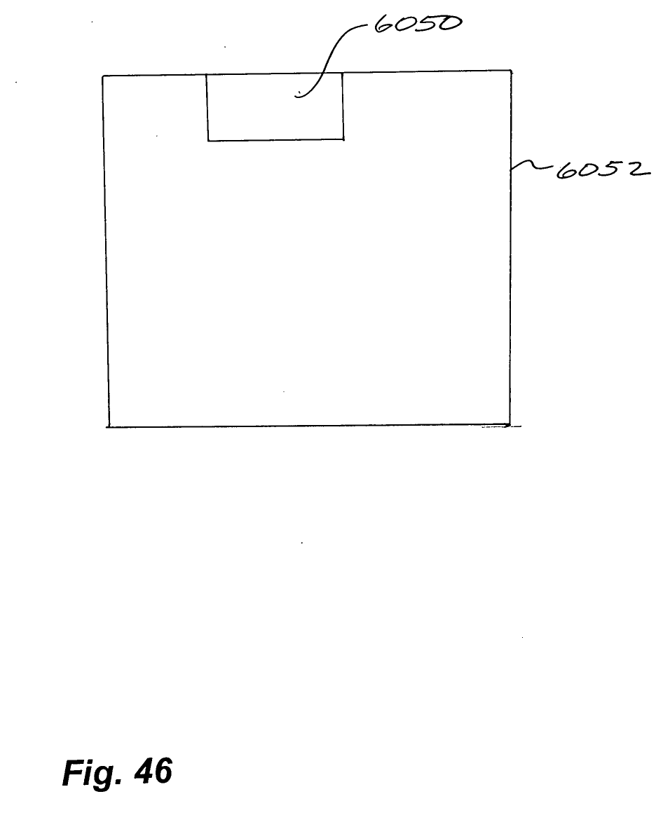

FIG. 46 shows a steam unit 6050, which is mounted in an enclosure 6052. The steam unit 6050 destroys bacteria in the enclosure 6052.

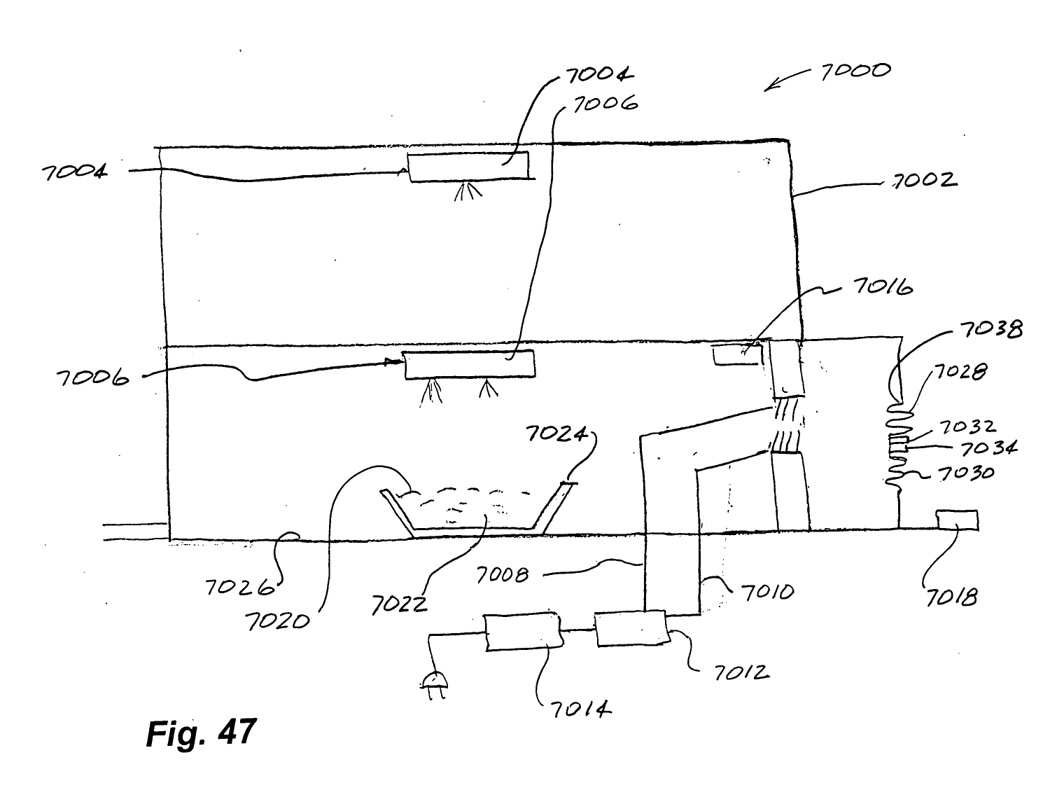

FIG. 47 shows a vacuum cleaner unit with sensors 7000 which includes an enclosure 7002 which has mister units 7004, 7006, ducts 7008, 7010 which allow the vacuum cleaner 7012 to clean any part of the enclosure 7002, a timer 7014 which controls the time of operation of the vacuum cleaner 7012, heat sensors 7016, 7018 which sense if a cat is in or near the enclosure 7002 and which prevents operation of the vacuum cleaner 7012 when the cat is in or near the enclosure 7002. The vacuum cleaner unit 7000 works on either battery or line current. Anti-bacterial powder or baking soda 7020 is deposited on litter 7022 which is placed in a tray 7024 which is mounted on sliding tracks 7026. Fabric portions and magnets 7032, 7034 close an opening 7038 in the enclosure 7002. An ion generator unit connected to a blower duct 7008 generates positive ions. A vacuum cleaner duct 7010 is connected to a source of negative ions. The inlet ring of the vacuum cleaner 7012 has a negative charge.

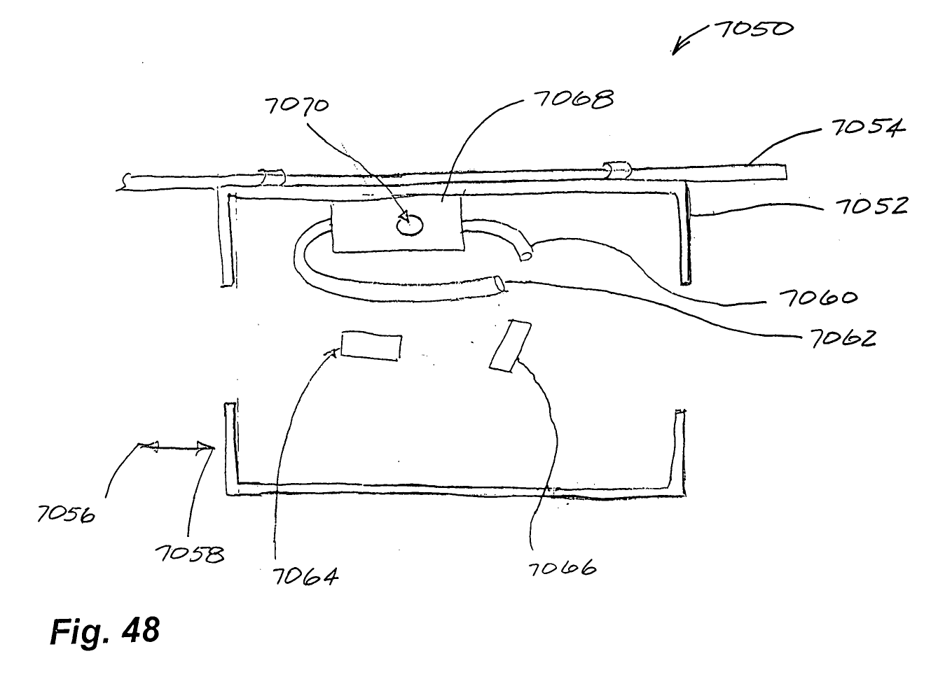

FIG. 48 shows a vacuum/blower/ionizer unit 7050 which has a plurality of ports and flex ducts which can be directed to all areas of an enclosure 7052. The unit 7050 may be slidably mounted on a track 7052 and moved in the directions shown by the arrows 7056, 7058. The vacuum duct 7060 and the blower duct are 7062 shown by way of example. The unit 7050 includes a positive ion generator 7064 and a negative ion generator 7066. The polarity of the generator 7064, 7066 may be reversed. The air flow from the blower 7068 can be controlled by a knob 7070 to vary the air flow in the enclosure 7052.

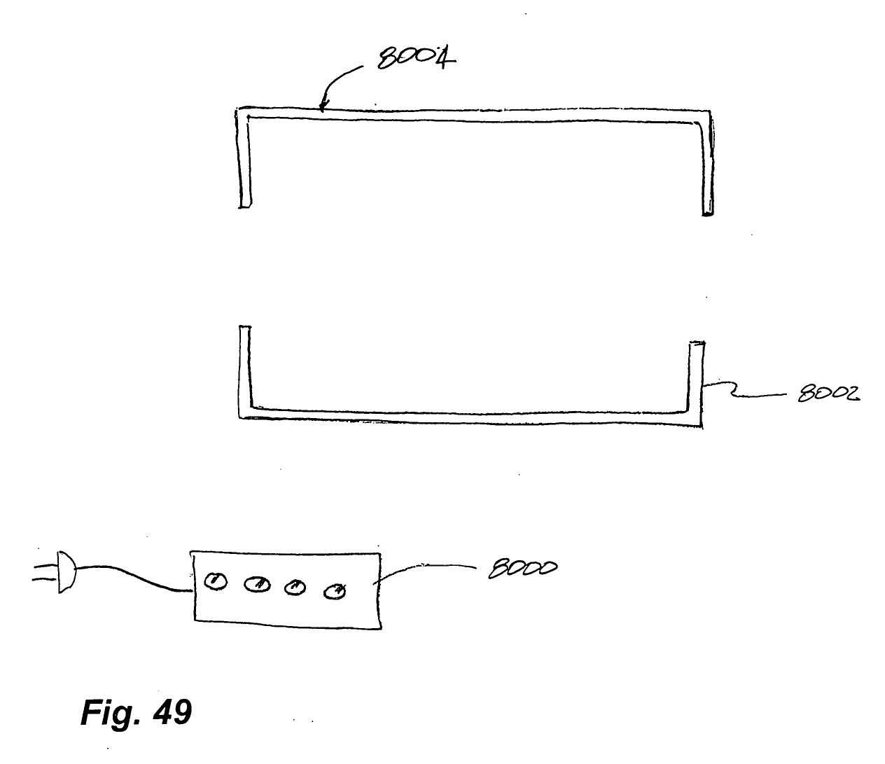

FIG. 49 shows a wireless control unit 8000 which cooperates with an enclosure, a section of which is shown as enclosure 8002. The enclosure includes a frame work of tracks and has provisions for various units including ducts and for electrical power 8004. The wireless control unit 8000 controls the operation of each of the units including on/off functions, speed and power.

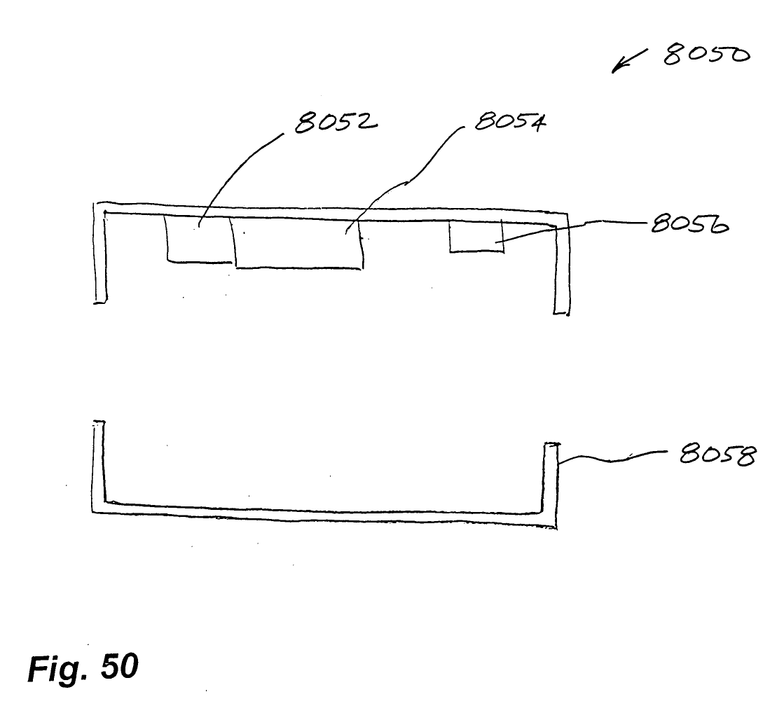

FIG. 50 shows an air freshener blower 8050 which includes a tank 8052 containing air freshener liquid, a blower 8054 and a heat sensor 8056 which turns the blower 8054 on when the animal is in the area of the heat sensor 8056. The air freshener blower 8050 is mounted in an enclosure 8058.

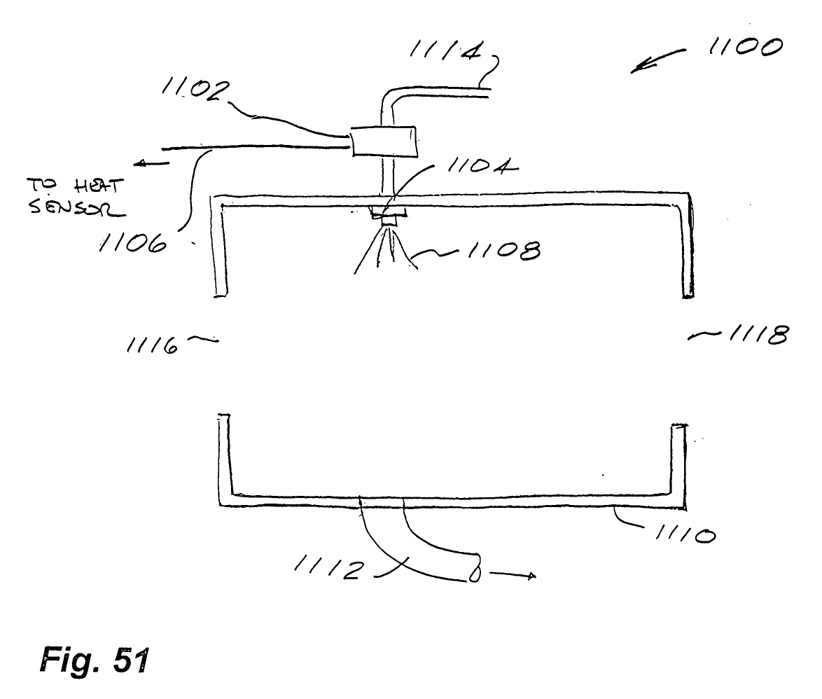

FIG. 51 shows an enclosure 1100 which includes a control valve 1102 which is connected a conduit 1114 and to a spray hood 1104 and to a heat sensor, not illustrated via a head 1106. The spray head 1104 dispenses a spray 1108. The floor 1110 of the enclosure 1100 includes a drain pipe 1112 which drains fluid from the enclosure 1100. The enclosure 1100 includes openings 1116, 1118.

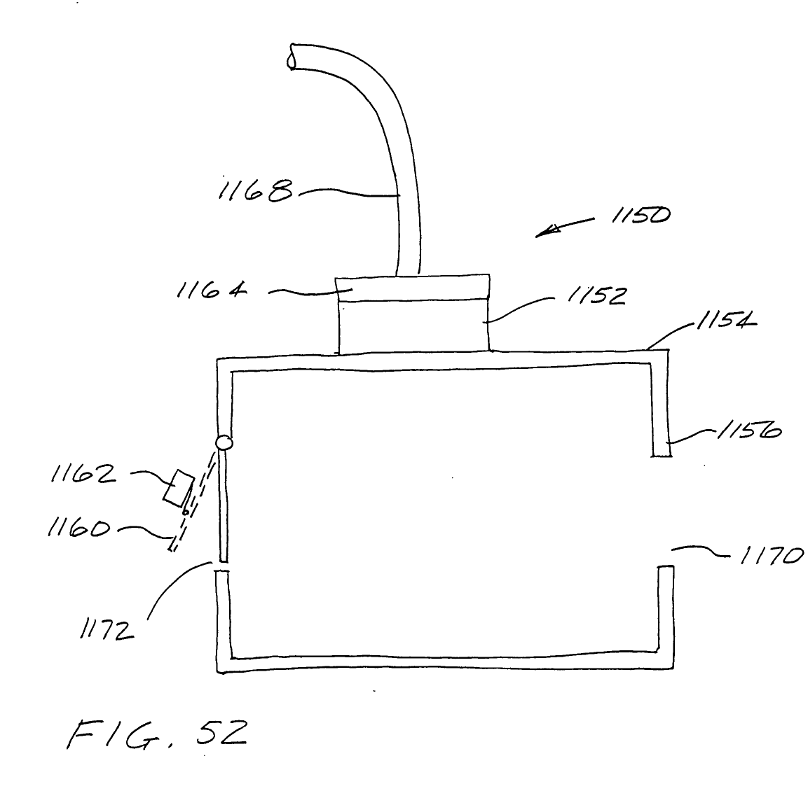

FIG. 52 shows a ventilator unit 1150 which includes a fan 1152 and which is mounted on the top wall 1154 of an enclosure 1156. The enclosure 1156 has a pair of openings 1170, 1172, one of which 1172 has an outwardly swinging door 1160 which operates a micro switch 1162. The micro switch 1162 turns the ventilator 1150 on when the cat leaves the enclosure 1156. The ventilator unit 1150 may have an anti-allergen charcoal filter, high efficient particles absolute, HEPA, filter or a u-v unit mounted above the fan 1152 in a compartment 1164 mounted above the fan 1152. The ventilator 1150 includes an optional flex duct 1168 which may lead to a house vent or to a window.

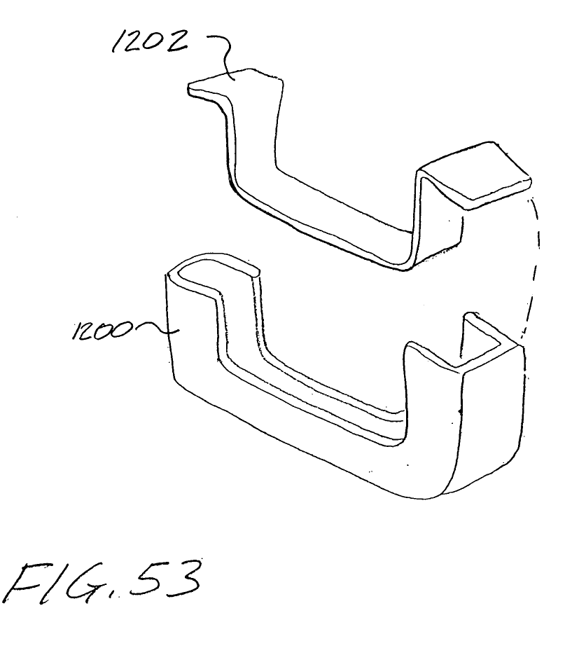

FIG. 53 shows a weight tank 1200 which may snap into the front cover of an enclosure which has not been illustrated. The weight tank 1200 includes a snap-on cover 1202.

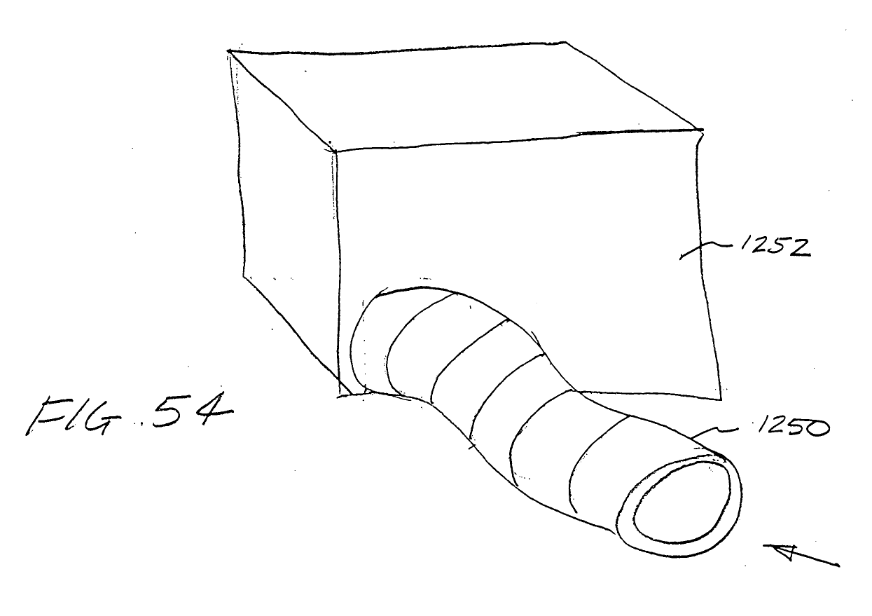

FIG. 54 shows a flexible entry duct 1250 which leads to an enclosure 1252. The flexible entry duct 1250 may be made of a bendable plastic tube.

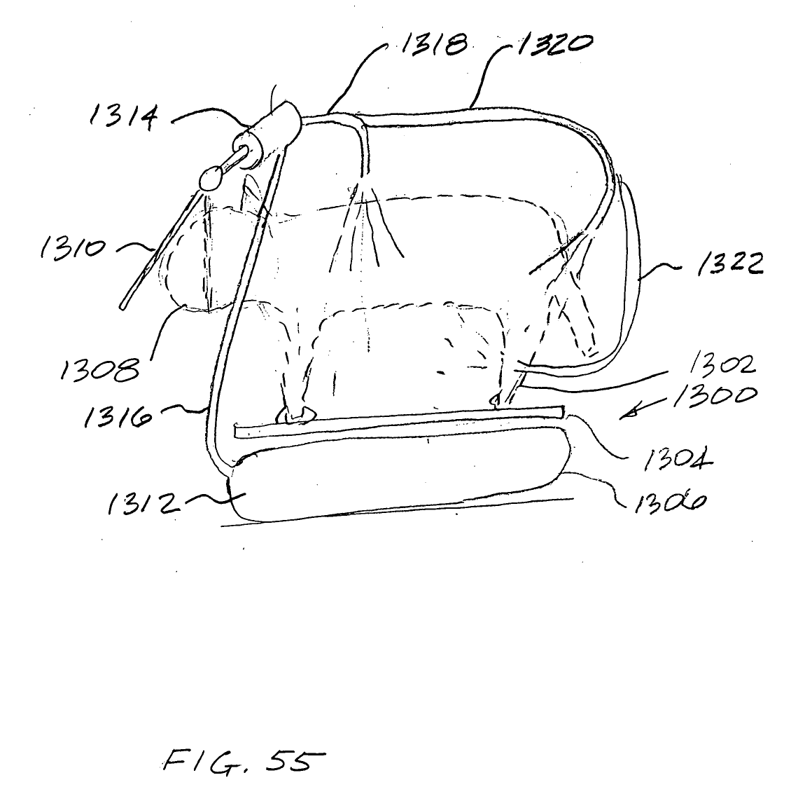

FIG. 55 shows a platform bladder assembly 1300 in which a cat 1302 steps on a platform 1304 which is mounted above a bladder 1306. The weight of the cat 1302 presses on the platform 1304 which in turn presses on the bladder 1306 which is filled with a combination of air and powder and pressurizes the bladder 1306, 1308. When the cat's head pushes against a bar 1310 which is mounted near an end 1312 of the bladder 1306, a valve 1314 which is connected to the bladder 1306 via a conduit 1316 opens and powder 1314 is sprayed on the cat 1302 via conduits 1318, 1320, 1322.

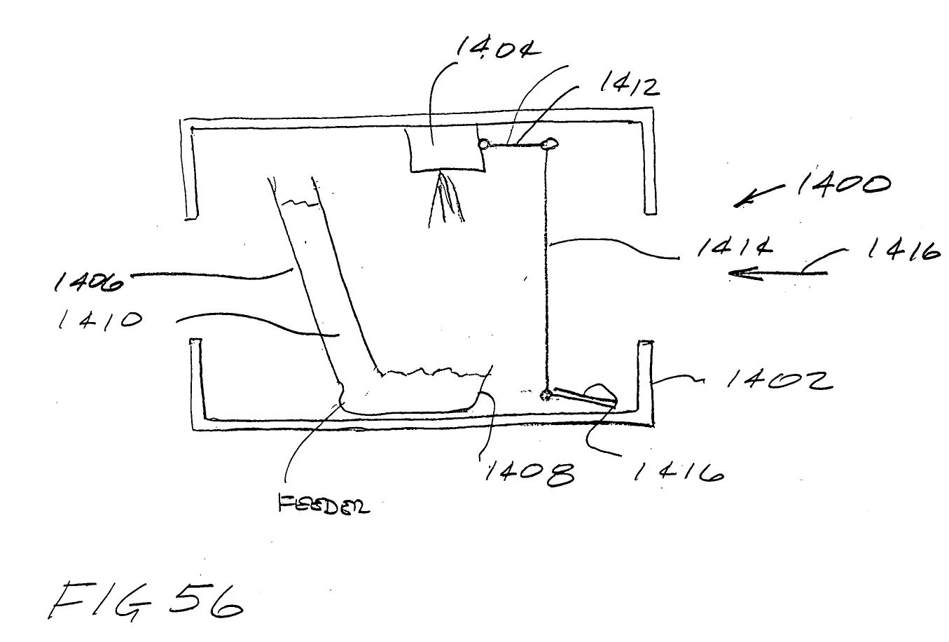

FIG. 56 shows a feeder/sprayer unit 1400 which is mounted in an enclosure 1402. A sprayer 1404 is mounted directly above the feeder 1406 which includes an integral folding dish 1408 and food storage duct 1410. The sprayer 1404 is actuated mechanically by links 1412, 1414 which are connected to a platform 1416 on which an animal steps when the animal enters the enclosure 1402 in the direction shown by the arrow 1416. The sprayer 1404 is directly above the animal when the animal eats from the feeding dish 1408.

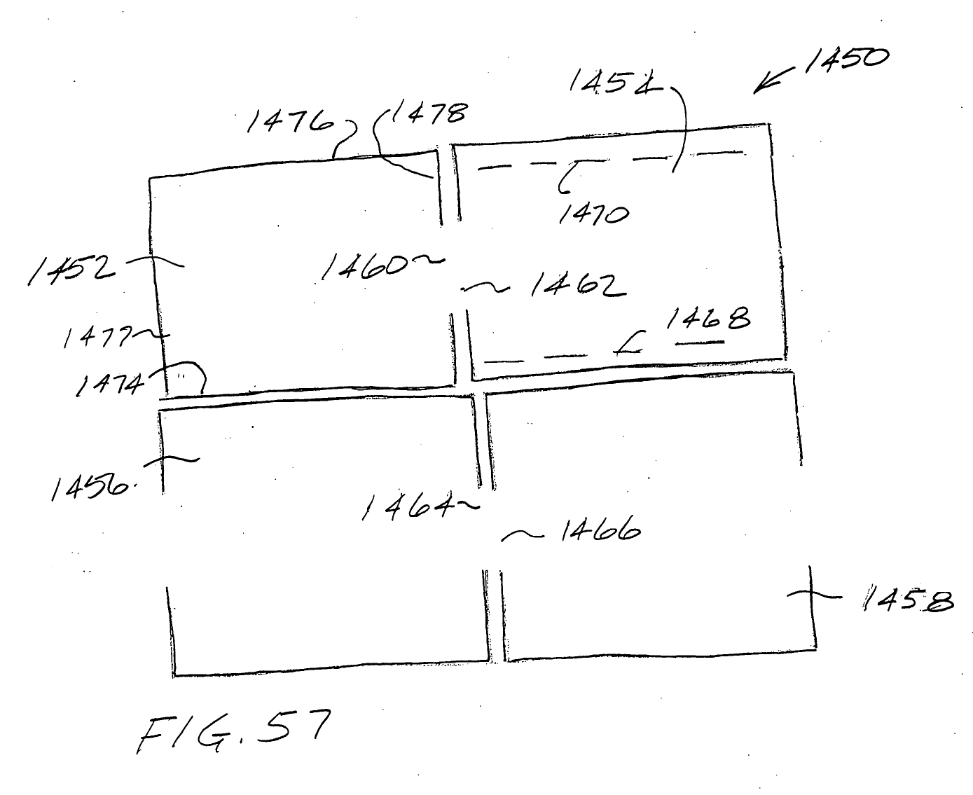

FIG. 57 shows an enclosure assembly 1450 which includes four compartments 1452, 1454, 1456, 1458 which are grouped together and which have connecting apertures 1460, 1462 and 1464, 1466. Each of the compartments 1452, 1454, 1456, 1458 include a pair of tracks which are indicated schematically by the broken lines 1468, 1470. Each compartment typically includes walls 1472, 1474, 1476, 1478.

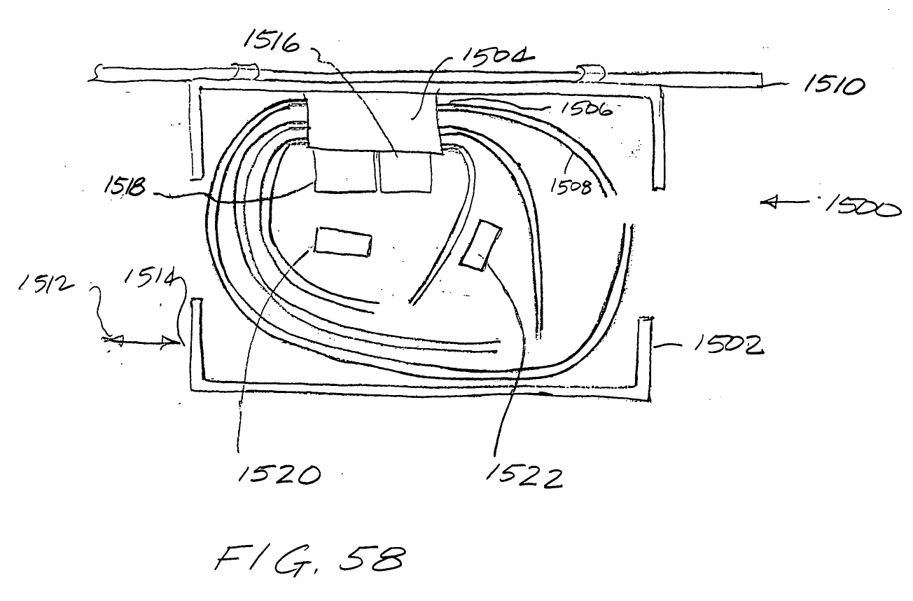

FIG. 58 shows a vacuum cleaner apparatus 1500 which includes an enclosure 1502 and a vacuum blower ionizer, u-v unit 1504, which has a plurality of ports 1506 each of which is connected to a flexible duct 1508. The flexible ducts 1508 may be directed to all areas of the enclosure 1502.

The apparatus 1500 may be slidably mounted on a track 1510. The track 1510 allows the apparatus 1500 to be moved in the directions shown by the arrows 1512, 1514. The unit 1504 also includes a mist generator 1516 and a dryer 1518. In addition, the unit 1504 includes a positive ion generator 1520 and a negative ion generator 1522. The polarity of the ions generated by each of these generators 1520, 1522 can be reversed.

The intensity of the blower and the vacuum can be controlled. In general, for optimum performance, the intensity of the blower is weaker than the vacuum.

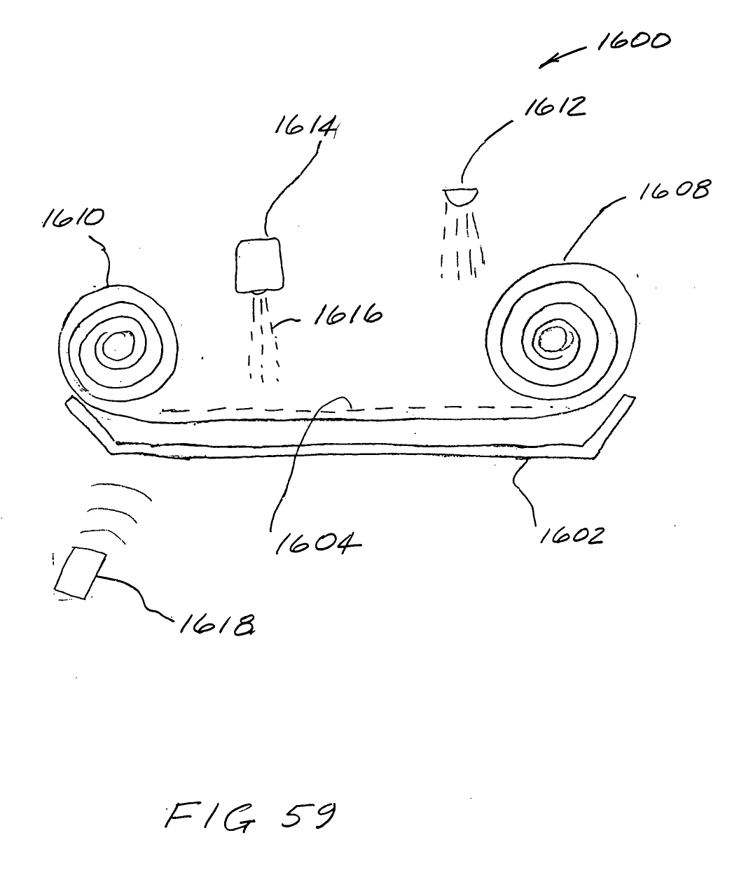

FIG. 59 shows a tray with a dual roll paper pad assembly 1600 which includes a tray 1602 and a screen 1604 which is disposed spaced above the tray 1602. A clean paper strip or pad 1606 is fed from a clean paper supply roll 1608, passing between the screen 1604 and the tray 1602 and is wound onto a used paper storage roll 1610.

A photo elastic beam 1612 is mounted above the assembly 1600 and when an animal breaks the beam 1612, the apparatus 1600 is turned on.

A supply tank 1614 deposits chemicals 1616 which may stimulate the animal. The supply tank 1614 may also be activated by a remote control unit 1618.

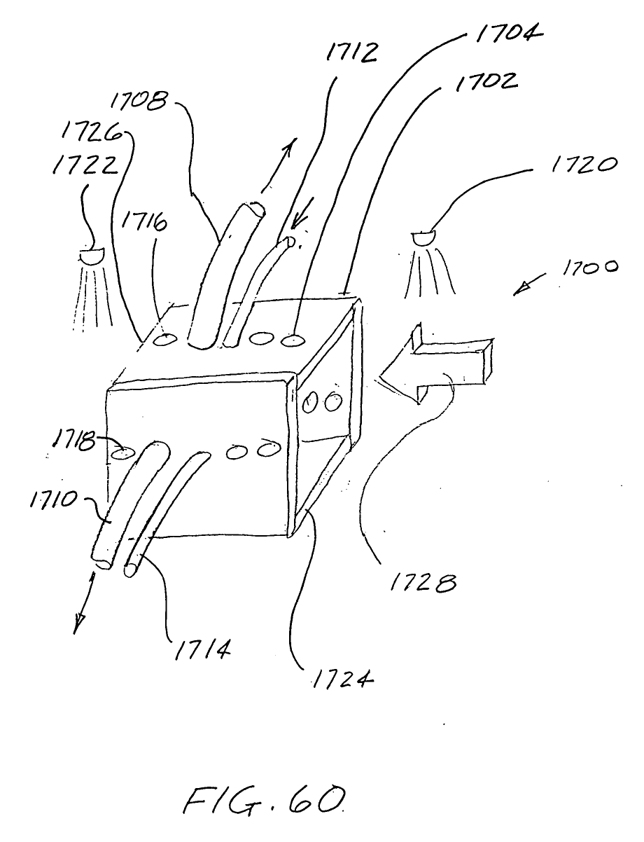

FIG. 60 shows a dual sensor hair erecting and dispensing system 1700 which includes an enclosure 1702 which includes a plurality of ports 1704. The ports 1704 are connected to ducts 1706 which are indicated typically by the ducts 1708, 1710, 1712, 1714. The ducts 1708, 1710 are connected to a vacuum blower while the ducts 1712, 1714 are connected to a dispenser.

The enclosure 1702 also includes negatively charged plates 1716, 1718. A pair of photo-electric beams 1720, 1722 is disposed, one each near each end 1724, 1726 of the enclosure 1702. When an animal which moves in the direction shown by the arrow 1728 breaks both beams 1729, 1722, the animal's hair is erected by the charged plates 1716, 1718 and spray, mist or powder can be dispensed via the ducts 1706. In addition, UV light treatment can be applied onto the skin of the animal including all portions of the hair of the animal from the dispenser. The vacuum blower aids in erecting the animal's hair.

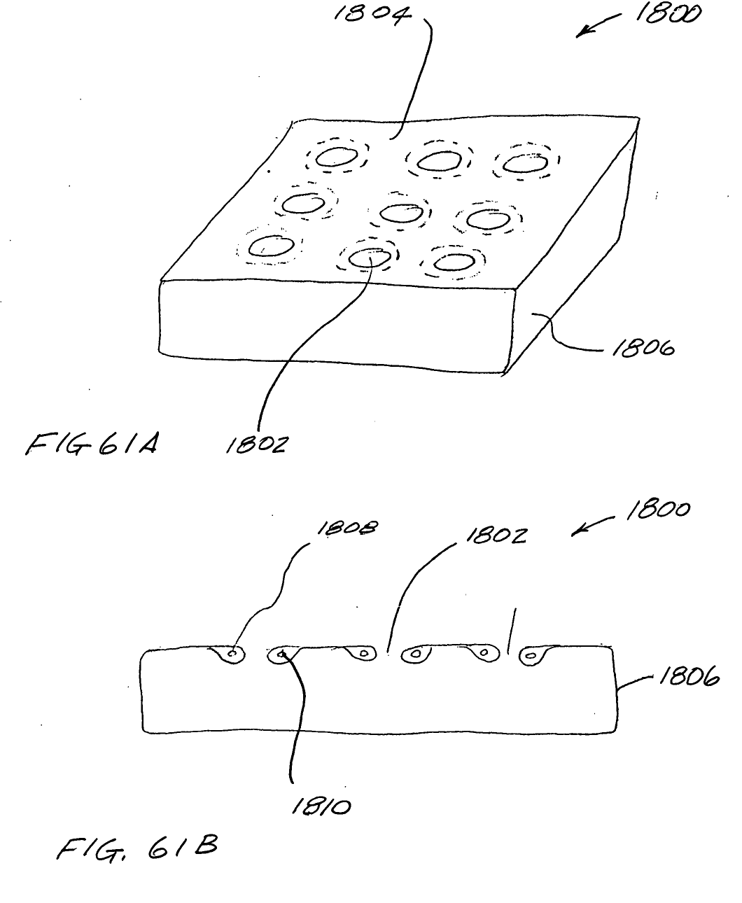

FIGS. 61A and 61B show a tray with elastic apertures 1800. The plurality of elastic apertures is indicated typically by the reference numeral 1802. The apertures 1802 are formed in a flexible film or sheet 1804 member which covers the tray 1806. Each of the apertures 1802 is defined by a hem 1808 which is formed in the sheet member 1804. Within each hem, there is an elastic band 1810. The apertures 1802 allow animals' feet to enter the tray 1806 for the application of treatment.

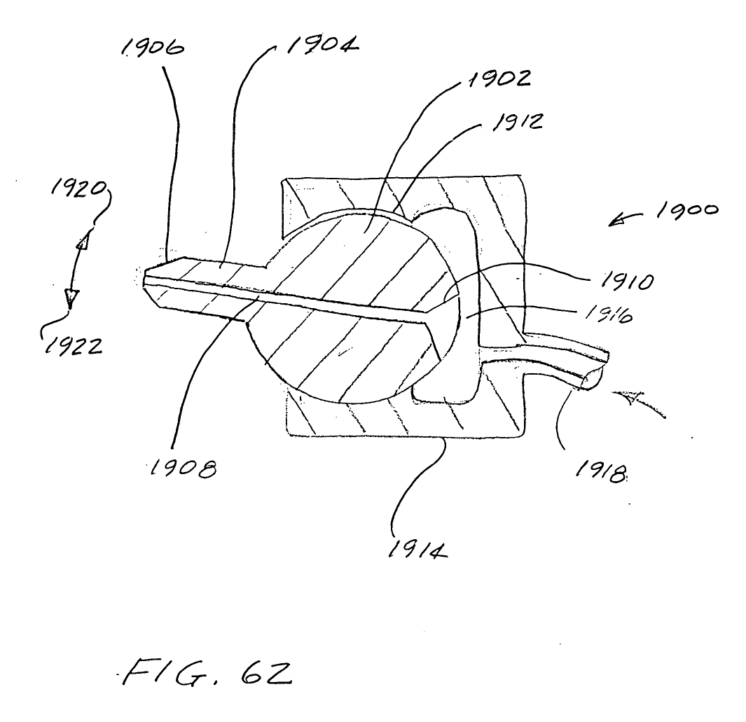

FIG. 62 shows an adjustable nozzle 1900. The nozzle 1900 includes a spherical portion 1902 and a cylindrical portion 1904 which ends in a conical tip 1906. The spherical and cylindrical portions 1902, 1904 include a common control bone 1908, the inlet end of which is outwardly flared 1910. The spherical portion 1902 is mounted in a spherical cavity 1912 formed in a housing 1914. The cavity includes a plenum portion 1916 which communicates with the inlet end 1910 of the central bore 1908.

An inlet tube 1918 leads to the plenum 1916. The tip 1906 may be moved in the directions shown by the arrows 1920, 1922 in FIG. 62 to direct a spray flowing from the nozzle in any desired directions.

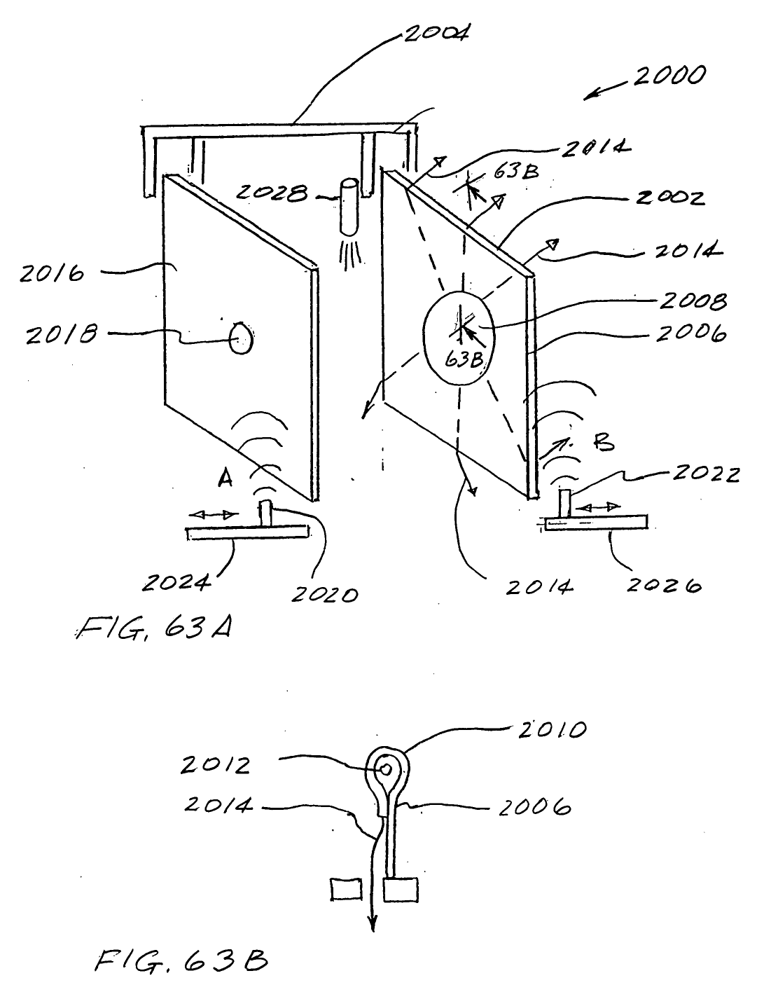

FIGS. 63A and 63B show a barrier assembly with an adjustable opening 2000. The barrier 2002 is mounted in a frame 2004 which fits into an enclosure which has not been illustrated. The barrier 2002 includes a flexible sheet 2006 having an aperture 2008. The aperture 2008 is defined by a hem 2010 formed in the sheet 2006. An elastic band 2012 such as a rubber-band is mounted within the hem 2010. The elastic band 2012 is disposed to bias the aperture 2008 to form an opening of reduced dimensions.

A plurality of strings 2014 are disposed connected to the hem 2010. Tension placed on the strings 2014 opposes the elastic force of the elastic band 2012 and forces the sheet 2006 to form an aperture 2008 of increased dimensions.

The apparatus 2000 includes a second sheet 2016 having an aperture 2018 with the second sheet spaced away from the sheet 2006 described above.

A pair of sensors 2020, 2022 is each mounted on a track 2024, 2026 with the sensors 2020, 2022 disposed proximate to the sheets 2006, 2016. The sensors 2020, 2022 may be moved along the tracks 2024, 2026 to change the distance to the sheets 2006, 2016. The sensors 2020, 2022 are generally mounted outwardly relative to the two sheets 2006, 2016. A spray unit 2028 is mounted between the two sheets 2006, 2016. The spray unit 2028 goes on when both sensor beams A and B are broken.

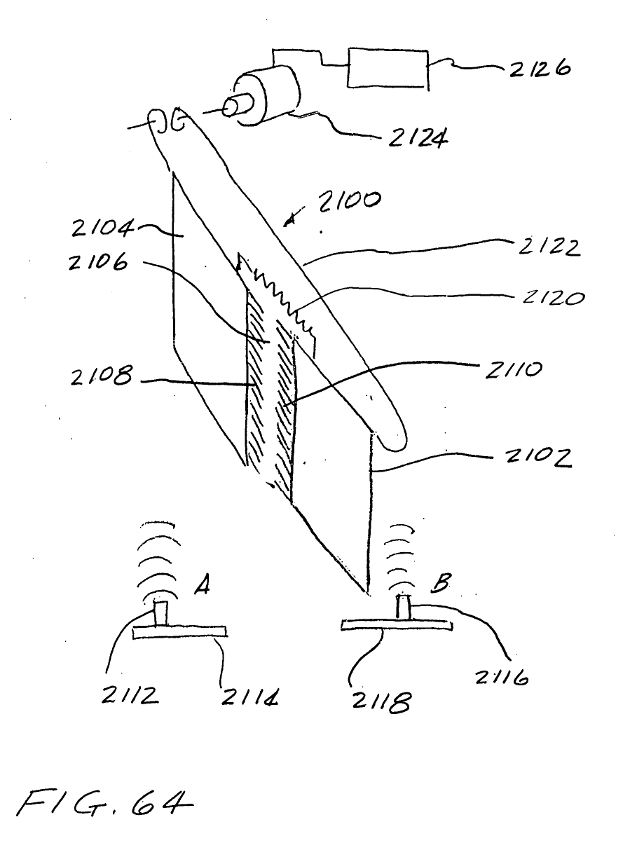

FIG. 64 shows a barrier 2100 which may be located at the opening of an enclosure, which has not been illustrated but which is similar to the enclosure previously described. The barrier 2100 includes a pair of spaced apart sheets 2102, 2104 which define an aperture 2106. Brushes 2108, 2110 mounted one each on the edges of the sheets 2102, 2104 project toward respectfully each other.

A first sensor 2112 designated by the letter A is mounted on a track 2114 which is attached to the enclosure and is disposed in front of the sheet 2104. A second sensor 2116 designated by the letter B is similarly mounted on a track 2118 attached to the enclosure and is disposed at the rear of the sheet 2102.

When sensor beam B is broken indicating that an animal's head is past the opening 2106, a spring 2120 connecting the sheets, or alternatively a filament 2122 connected to the motor 2124 which is connected to a controller 2126 brings the brushes 2108, 2110 close together to brush the animal's body and the animal's tail.

When the animal leaves the enclosure, sensor beam A is broken and the motor 2124 opens the space between the brushes 2106, 2110. When the sensor beam B is broken, the motor or a spring brings the brushes 2106, 2110 together.

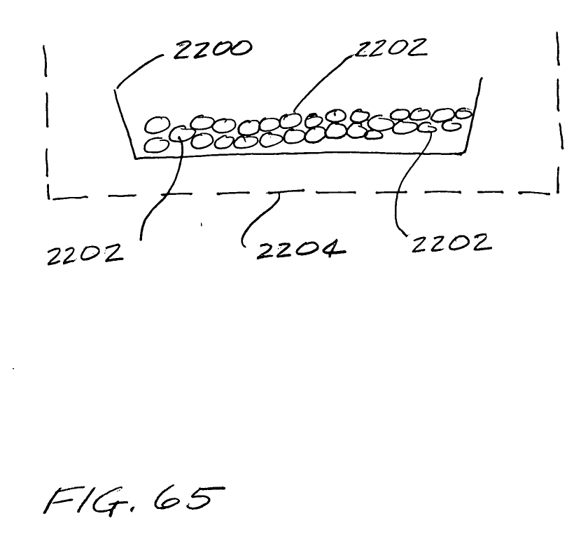

FIG. 65 shows a tray 2200 with a plurality of stones 2202 which may be used to treat an animal's nail. The enclosure 2204 is shown schematically in broken lines. A plurality of stones is disposed in the tray 2200 which is located within the enclosure 2204. An animal traversing the tray 2200 has its nails treated by frictional contact with the stones 2202.

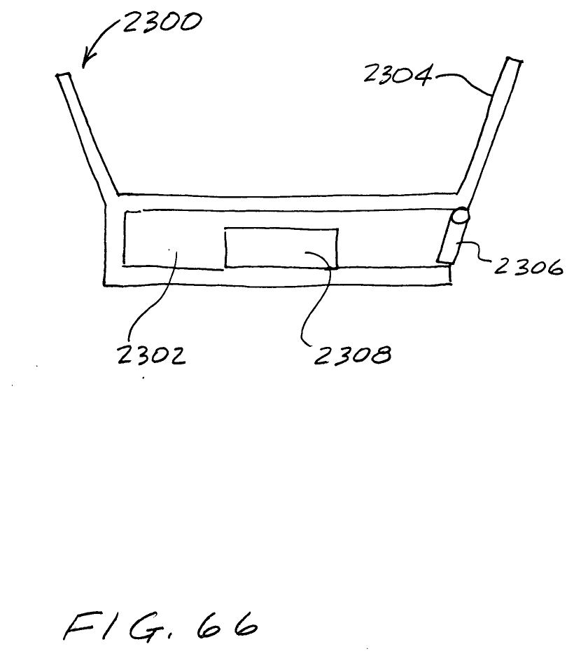

FIG. 66 shows a dish with a dry ice compartment 2300. The dry ice compartment 2302 disposed below an open compartment 2304 which may be used for the storage of food or water. The dry ice compartment 2302 includes a door 2306 which may be used to insert a block of dry ice 2308 into the dry ice compartment 2302. The dry ice 2308 maintains the food or water in the open compartment 2304 in a fresh condition.

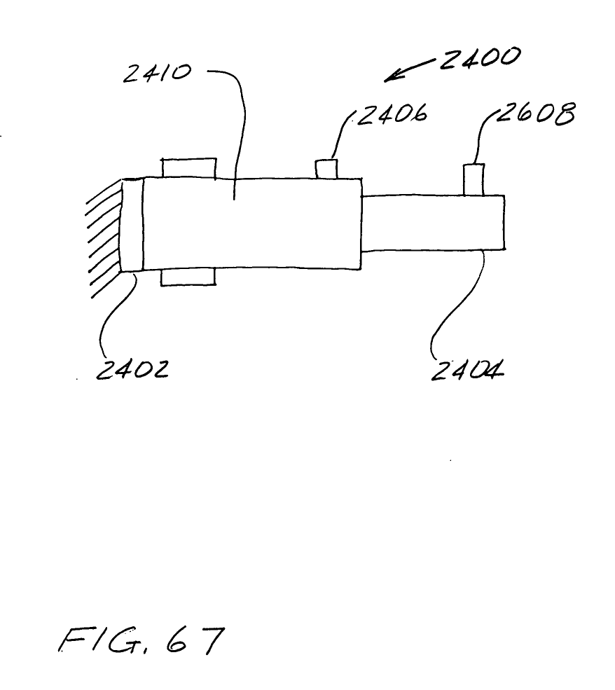

FIG. 67 shows a brush with a vacuum, blower, U-V light and flea zapper unit 2400. The brush 2400 includes interchangeable bristles 2402, a handle 2404 and attachment lugs 2406, 2408 for attachment of the unit 2400 to a track for mounting in an enclosure. The base of the unit includes a vacuum, blower, U-V light and flea zapper unit 2410.

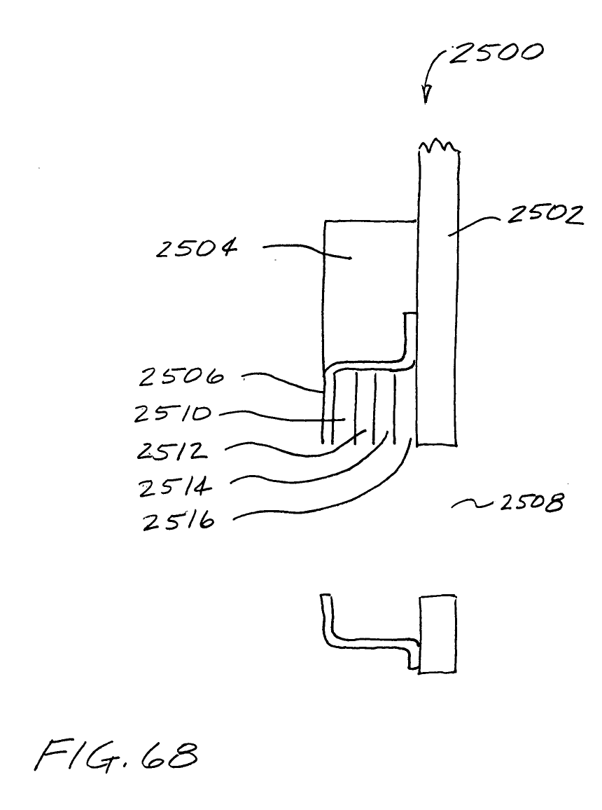

FIG. 68 shows a door opening with treatment unit 2500. The unit includes a door 2502 which has an apparatus compartment 2504 which is located above a discharge area 2506 which is located above an opening 2508 in the door. The discharge area includes a blower unit 2510, an ion unit 2512, a U-V unit 2514, and a mist unit 2516.

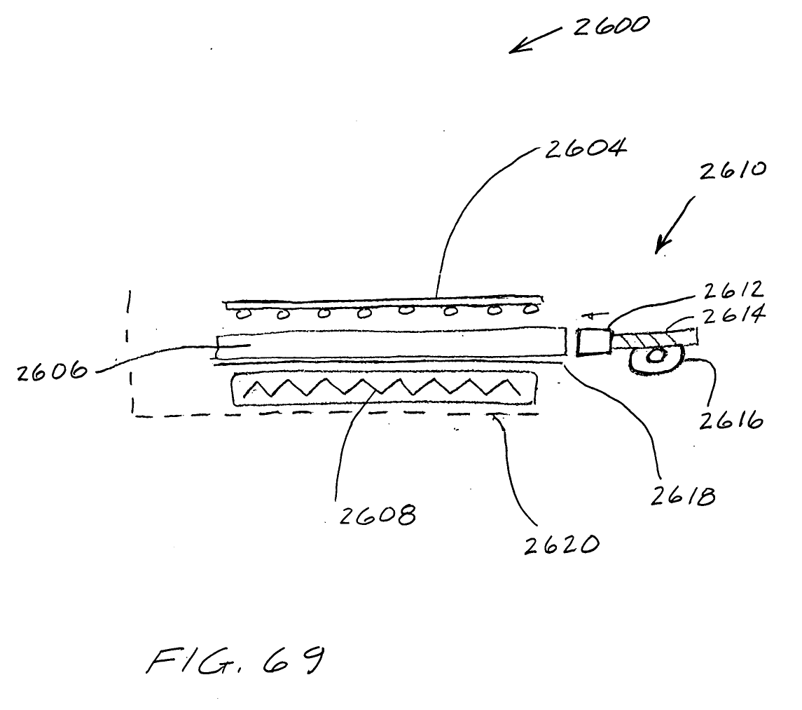

FIG. 69 shows a wax layer carpet assembly 2600 which may be placed in an enclosure 2620. The assembly 2600 includes a screen layer 2604 which is disposed above a wax layer 2606. The wax layer rests on a support layer 2628 disposed below the wax layer 2606 and maintains the wax layer 2606 in a soft state. The screen 2604 allows the cat's nails to project through the apertures in the screen 2604 and come into contact with the soft wax layer 2606. The wax transfers to the cat's nails and hardens on the cat's nails as the wax cools. A new supply of wax is added to the wax layer 2606 by a pusher assembly 2610, which preferably includes a pusher block 2612 which is driven by a worm gear 2614 which is rotated by an electric motor 2616.

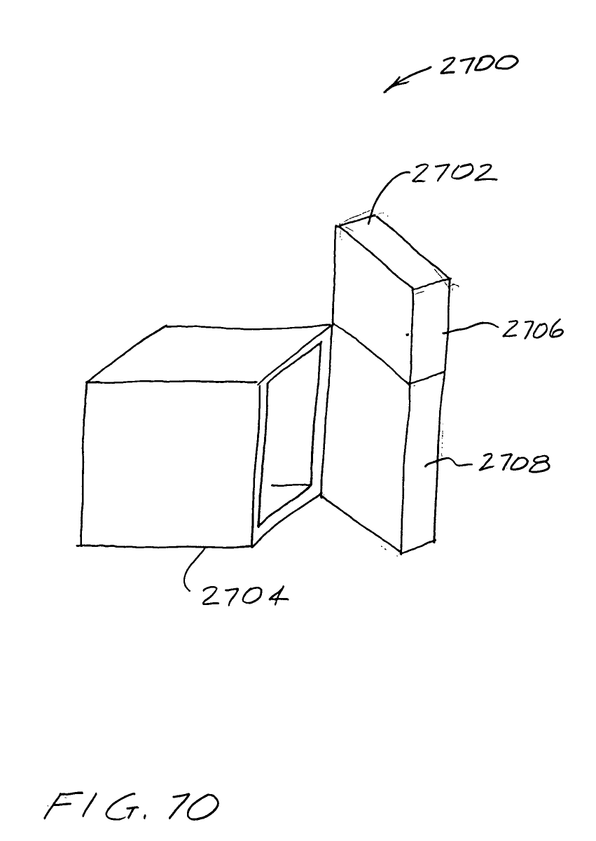

FIG. 70 shows a door space saver assembly 2700 which forms the door 2702 of an enclosure 2700. The assembly preferably includes an apparatus 2706 which is mounted above a treatment area 2708.

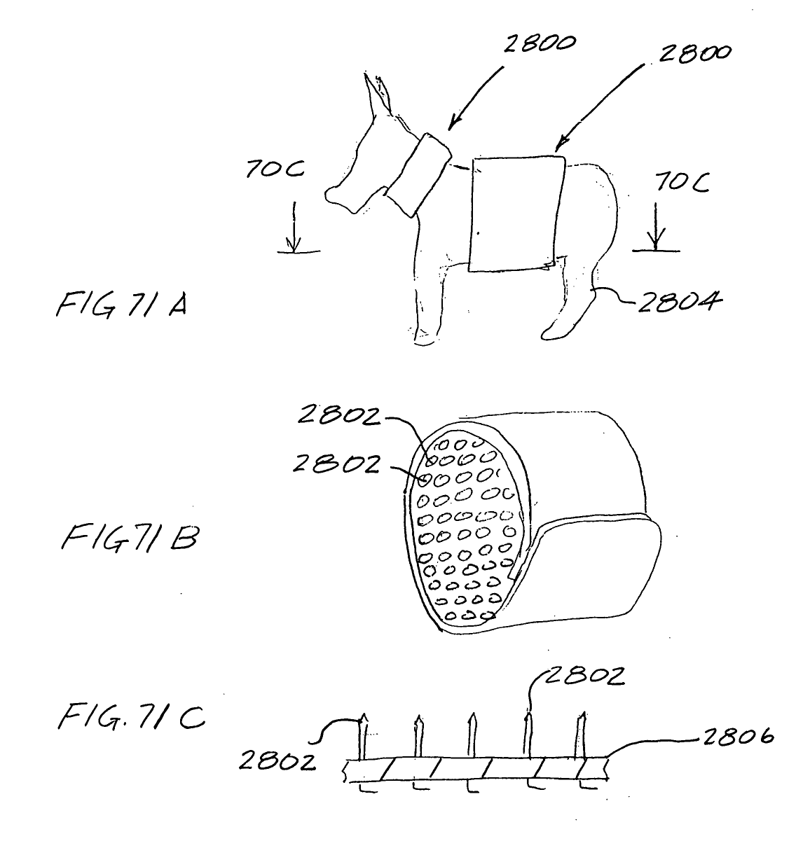

FIG. 71A shows a collar or a band apparatus 2800 which has multiple bins 2802. The pins 2802 may be electrified selectively so that individual pins or groups of pins 2802 may be electrified to provide electrical stimulus to the animal 2804. The stimulus may be directional or in the form of a picture. The pins 2802 are shown schematically in perspective in FIG. 70B and in a fragmentary sectional view in FIG. 70C. The pins 2802 are mounted on a band 2806.

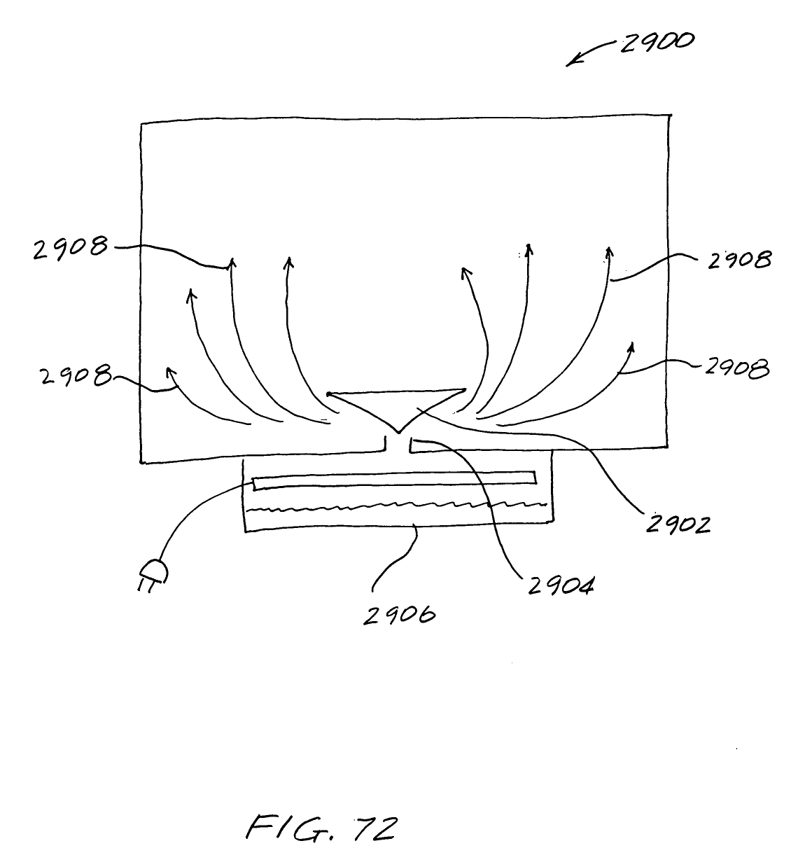

FIG. 72 shows a vaporizer unit with a broad dispersion baffle 2900. The baffle 2902 is mounted directly above the exit port 2904 of a vaporizer chamber 2906 and the outwardly flaring conical shape causes the mist to disperse broadly as indicated by the flow lines 2908.

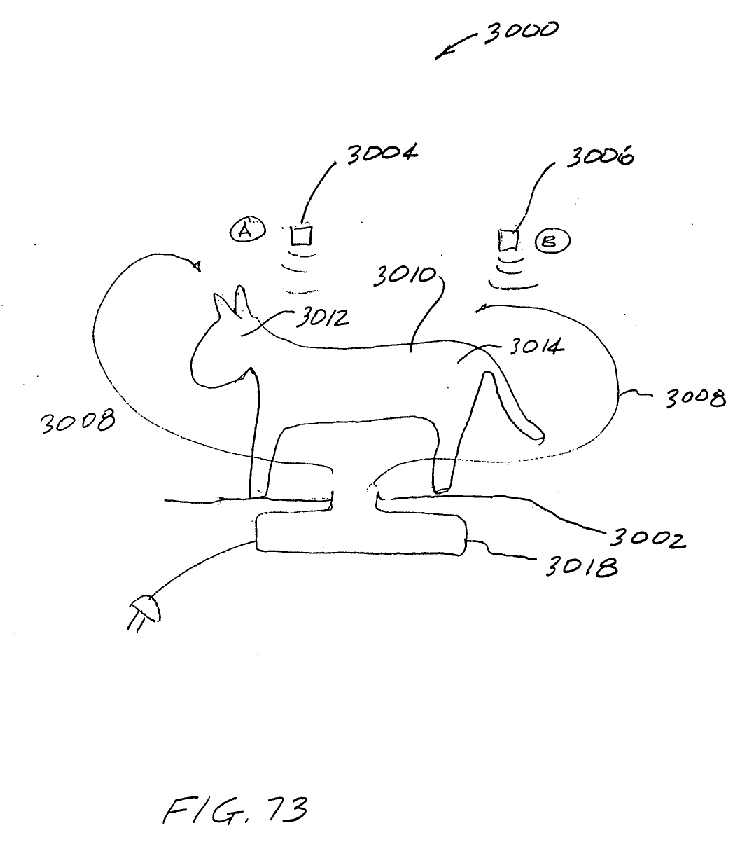

FIG. 73 shows a vaporizer unit 3000 which includes a vaporizer 3018 which is mounted below a platform 3002. A pair of sensors 3004, 3006 are mounted above and spaced away from the platform 3002. The sensors 3004, 3006 are connected to the vaporizer unit 3018 and allow vapor 3008 to flow onto the body 3010 but not onto the head 3012 of an animal 3014 which walks onto the platform 3002. The vaporizer 3000 thus provides a narrow defined ring of vapor 3000 which the animal 3014 passes through.

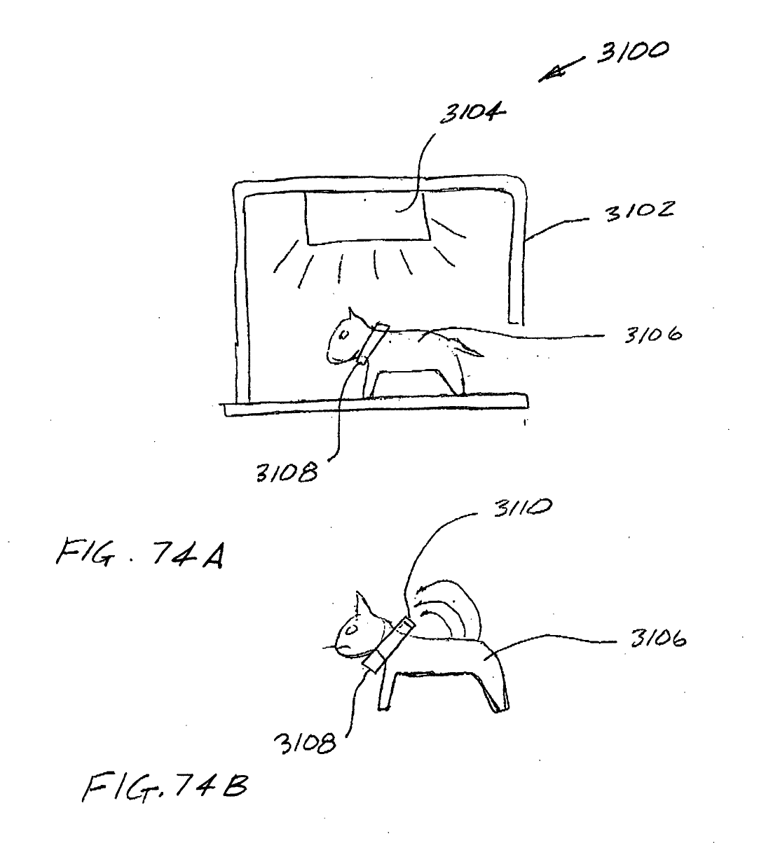

FIGS. 74A and 74B show a combination cleaner and collar 3100 which include an enclosure 3102 within which there is a negative ion generator 3104. The animal 3106 wears a collar 3108 which can be turned on when the animal 3106 leaves the enclosure 3102. The collar 3108 has a positive ion generator 3110 which attracts negatively charged particles. The collar 3108 operates on a continuous basis except when the animal enters the enclosure 3102.

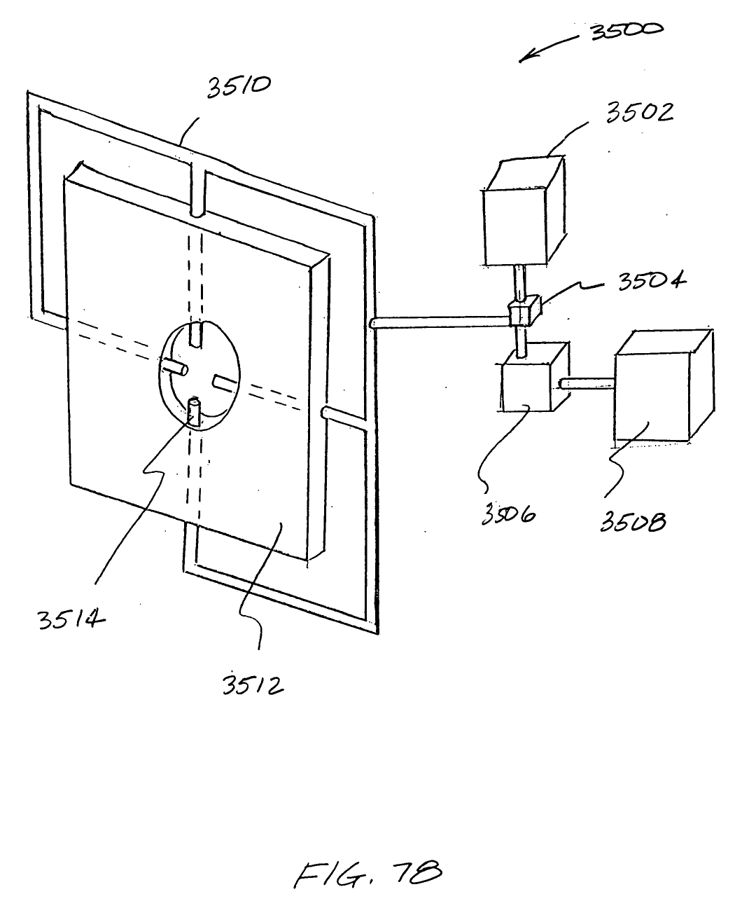

FIG. 78 shows a flexible barrier with elastic opening and nozzles 3500 which include a compressed air supply 3502, a valve 3504, a pump 3506, a tank 3508 which contains a solution, a plurality of tubes 3510 which pass through a flexible barrier 3512 and which terminate in stems with nozzles 3514, 3516, 3518, 3520 disposed within an aperture 3520 formed in the flexible barrier 3512. The valve 3504 allows solution to be pumped through the nozzles 3514, 3516, 3518, 3520. Compressed air can be blown through the nozzles 3514, 3516, 3518, 3520 to clean the nozzles 3514, 3516, 3518, 3520.

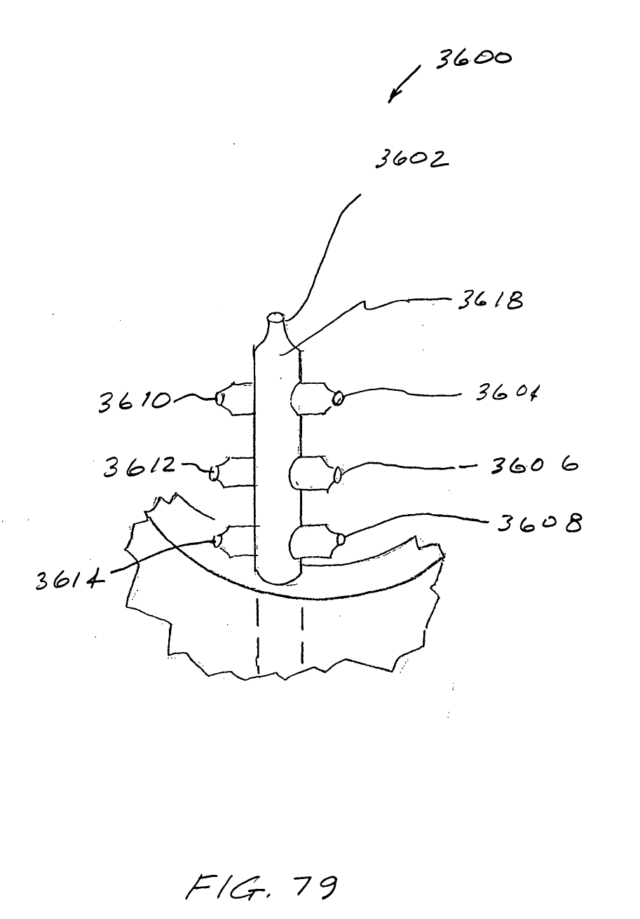

FIG. 79 is an enlarged view of a typical hollow stem and nozzles 3600. The portions 3602, 3604, 3606, 3608, 3610, 3612, 3614 of the stem are relatively thin. The central port 3618 of the stems is made of hard hollow rubber that does not bend. The end portion of the stems 3602, 3604, 3606, 3608, 3610, 3612, 3614 can bend or give or deflect because they are thin.

The foregoing specific embodiments of the present invention as set forth in the specification herein are for illustrative purposes only. Various deviations and modifications may be made within the spirit and scope of the invention without departing from the main theme thereof.

1. An animal cleaner apparatus comprising:
an enclosure;
a feeder unit comprising an electric motor actuator for operation of said lid;
a blower;
a programmable container;
electrical connections connecting said electric motor actuator, said blower and said controller for operation of said lid and said blower.

2. The animal cleaner apparatus as claimed in claim 1 further comprising a light unit and electrical connection connecting said light unit and said controller.

3. The animal cleaner apparatus as claimed in claim 1 further comprising a rotating tube unit.

4. The animal cleaner apparatus as claimed in claim 1 wherein said controller further comprises a remote control unit.

5. The animal cleaner apparatus as claimed in claim 1 further comprising a vacuum blower unit.

6. The animal cleaner apparatus as claimed in claim 1 further comprising an electrostatic generator unit.

7. The animal cleaner apparatus as claimed in claim 1 further comprising a plurality of flashing colored lights.

8. The animal cleaner apparatus as claimed in claim 1 further comprising a sound generator unit.

9. The animal cleaner apparatus as claimed in claim 1 further comprising an ultra-violet light unit.

10. The animal cleaner apparatus as claimed in claim 1 further comprising a spray unit.

11. The animal cleaner apparatus as claimed in claim 1 further comprising an ion generator unit.

12. The animal cleaner apparatus as claimed in claim 1 wherein said enclosure comprises a plurality of sliding panels.
